(19) United States
(12) Patent Application Publication
(10) Pub. No.: US 2013/0246144 A1
(43) Pub. Date: Sep. 19, 2013

(54) TRANSACTION ADVISORY BASED MERCHANT VOUCHER REDEMPTION

(71) Applicants: Erich L. Ringewald, Belvedere, CA (US); Amit Gaur, San Francisco, CA (US)

(72) Inventors: Erich L. Ringewald, Belvedere, CA (US); Amit Gaur, San Francisco, CA (US)

(73) Assignee: Boku, Inc., San Francisco, CA (US)

(21) Appl. No.: 13/423,853

(22) Filed: Mar. 19, 2012

(51) Int. Cl. G06Q 30/02

(52) U.S. Cl. 705/14.23

(57) ABSTRACT

A plurality of merchant accounts are stored in a data store. A voucher entry is received over from a merchant computer system and stored in the data store. A charge advisory is received and used to identify a selected one of the voucher entries. A notification is received from a server computer system bank account of settlement from a merchant account payment infrastructure of a discount amount of the voucher entry. A central account is updated based on the notification. A settlement instruction is transmitted for settlement based on the discount amount. The last one central account is updated based on the settlement instruction.

### BACKGROUND OF THE INVENTION

1). Field of the Invention

This invention relates generally to a transactions network and to a method and system for managing electronic transactions.

2). Discussion of Related Art

A customer who visits a store often uses a point-of-sale instrument such as a bank card or a credit card to pay for an item or items that are being purchased. The point-of-sale instrument communicates with a point-of-sale device such as a credit card reader. The point-of-sale device forms part of a point-of-sale network that communicates a charge request to a merchant acquirer computer system and the merchant acquirer computer system routes the charge to credit card and issuer computer systems forming part of the point-of-sale network. The credit card and issuer computer systems may for example include a credit card account to which an amount recorded on the point-of-sale device can be charged if sufficient funds or credit are available. The credit card and issuer computer systems then return a confirmation through the merchant acquirer computer system to the point-of-sale device that the transaction is good, whereafter an operator of the point-of-sale device will allow the customer to leave the store with the item or items that are being purchased.

Electronic transactions can be conducted in a similar manner. In the case of electronic transactions, a user can enter details of a point-of-sale instrument into an interface. Once the details are received, a charge request can be transmitted to a merchant acquirer computer system, and then be processed in a similar manner.

### SUMMARY OF THE INVENTION

The invention provides a computer system for managing electronic transactions, including a server computer system having a processor, a computer-readable medium connected to the processor, a network interface device connected to the processor and a set of instructions on the computer-readable medium, the set of instructions being executable by the processor. The set of instruction includes a plurality of merchant accounts stored in the data store, each merchant account having a merchant account identifier, a merchant account management system receiving a voucher entry over the network interface device from a merchant computer system, the merchant offer being stored in the data store in association with the merchant account having the respective merchant account identifier, a transaction clearing system that receives a charge advisory over the network interface device, the charge advisory including a second consumer account identifier, a voucher redemption system matching the second merchant account identifier to one of the first merchant account identifiers to identify a selected one of the voucher entries associated with the merchant account having the first merchant account identifier and a settlement system. The settlement system has (i) at least one central account, (ii) a merchant payment management module receiving a notification from a server computer system bank account of settlement from a merchant account payment infrastructure of the discount amount, and updating the at least one central account based on the notification, and (iii) a network payment management module transmitting a settlement instruction for settlement based on the discount amount, and updating, with the processor, the at least one central account based on the settlement instruction.

The invention further provides a computer-based method of managing electronic transactions, including storing, with a processor, a plurality of merchant accounts in a data store, each merchant account having a first merchant account identifier, receiving, with the processor, a voucher entry over a network interface device from a merchant computer system, storing, with the processor, the voucher entry having a discount amount in the data store in association with the merchant account having the respective first merchant account identifier, receiving, with the processor, a charge advisory over the network interface device, the charge advisory including a second consumer account identifier, matching, with the processor, the second merchant account identifier to one of the first merchant account identifiers to identify a selected one of the voucher entries associated with the merchant account having the first merchant account identifier, receiving, with the processor, a notification from a server computer system bank account of settlement from a merchant account payment infrastructure of the discount amount, updating, with the processor, at least one central account based on the notification, transmitting, with the processor, a settlement instruction for settlement based on the discount amount and updating, with the processor, the at least one central account based on the settlement instruction.

### BRIEF DESCRIPTION OF THE DRAWINGS

The invention is further described by way of example with reference to the accompanying drawings, wherein:

FIG. 1 is a block diagram of a transactions network according to an embodiment of the invention;

FIG. 2 is a block diagram of a mobile device, consumer account setup module, consumer account management system, consumer account and consumer account funding infrastructure forming part of the transactions network;

FIG. 3A is a view that is displayed in an interface of the mobile device to prompt a consumer to register a consumer account or to log into an existing account;

FIGS. 3B and 3C are views similar to FIG. 3A wherein the consumer registers a new account;

FIGS. 3D and 3E are views similar to FIG. 3A wherein the consumer logs into an existing consumer account;

FIG. 3F is a view similar to FIG. 3A wherein the stores bank account details for the consumer account;

FIG. 4 is a block diagram of a merchant account, a merchant account management system, a merchant computer system, in a merchant account payment infrastructure forming part of the transactions network;

FIG. 5A is a screenshot that appears within a browser of the merchant computer system for the merchant to log into the account;

FIG. 5B is a view similar to FIG. 5A permitting the merchant to enter initial details of a voucher, including a discount amount and start and end date;

FIG. 5C is a view similar to FIG. 5B where the merchant can upload a voucher image;

FIG. 5D is a view similar to FIG. 5C where the merchant can select specific terminals or groups of terminals where the offer will be valid;

FIG. 5E is a view similar to FIG. 5D where the merchant can view the offer before approving the offer;

FIG. 5F is a view similar to FIG. 5E after the offer has been approved by the merchant;

FIG. 5G is a view similar to FIG. 5F displaying multiple campaigns based on the merchant account;

FIG. 6 is a block diagram illustrating multiple merchant accounts and a voucher management system for purposes of managing transactions based on voucher entries;

FIG. 7 is a view that is displayed in the mobile device after a consumer has logged the mobile device into a particular consumer account;

FIGS. 8A and 8B are views that are displayed to the consumer of vouchers and specifics of vouchers, respectively;

FIG. 9 is a block diagram illustrating a point-of-sale instrument, a point-of-sale network, and a transaction clearing system of the transactions network;

FIG. 10 is a block diagram illustrating the consumer account and other components of preceding drawings that are used for processing a transaction against the consumer account;

FIGS. 11A and 11B illustrate notifications that are displayed on the interface of the mobile device after a transaction has been processed, and a discount has been applied;

FIG. 12 is a view similar to FIG. 7 after a number of transactions have been processed;

FIG. 13 is a view that is displayed in the mobile device of transactions for which the account has been used;

FIG. 14 is a view similar to FIG. 13 of categories of transactions;

FIG. 15 is a view similar to FIG. 14 of one category of transactions;

FIG. 16 is a block diagram illustrating functioning of a settlement system;

FIG. 17 is a block diagram of a machine in the form of a computer system forming part of the transactions network; and

FIG. 18 is a block diagram of the mobile device illustrating SmartPhone features thereof.

### DETAILED DESCRIPTION OF THE INVENTION

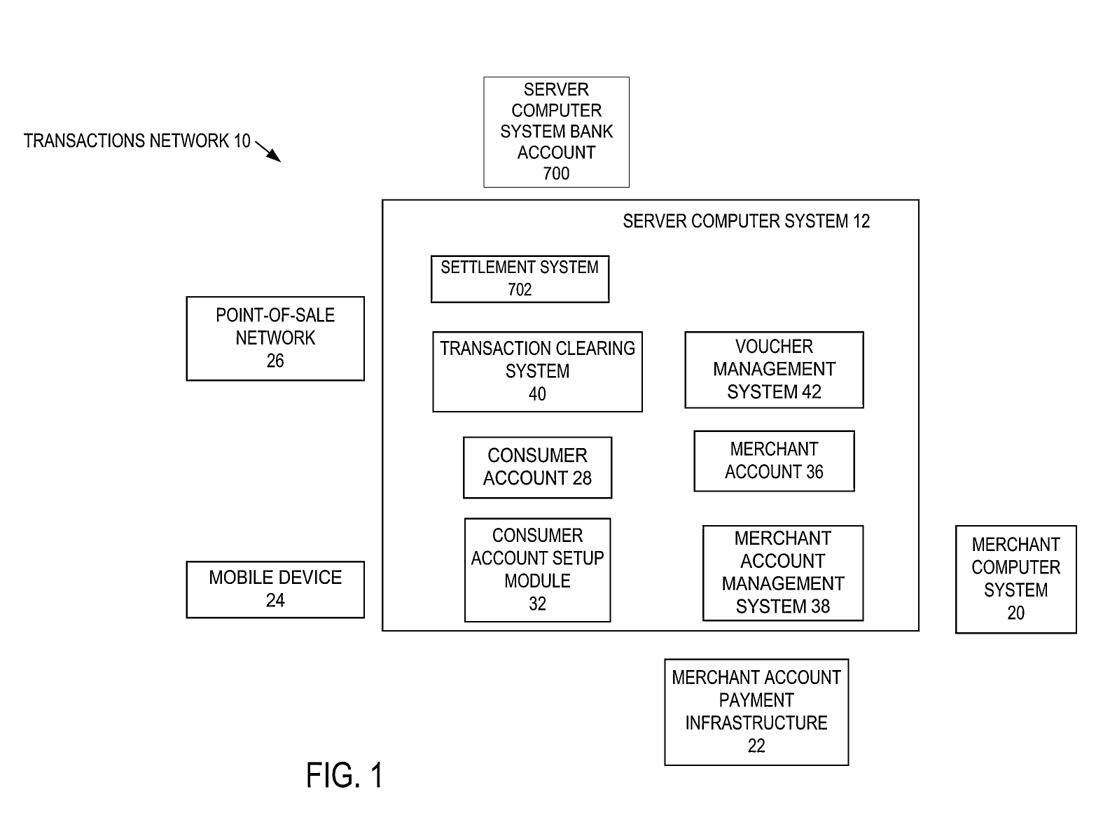

FIG. 1 of the accompanying drawings illustrates a transactions network 10, according to an embodiment of the invention, including a server computer system 12, a merchant computer system 20, a merchant account payment infrastructure 22, a consumer device in the form of a mobile device 24, and a point-of-sale network 26.

The server computer system 12 includes a plurality of consumer accounts (only one consumer account 28 shown), a consumer account setup module 32, a plurality of merchant accounts (only one merchant account 36 shown), a merchant account management system 38, a transaction clearing system 40, a voucher management system 42, and a settlement system 702.

### 1). Mobile Application

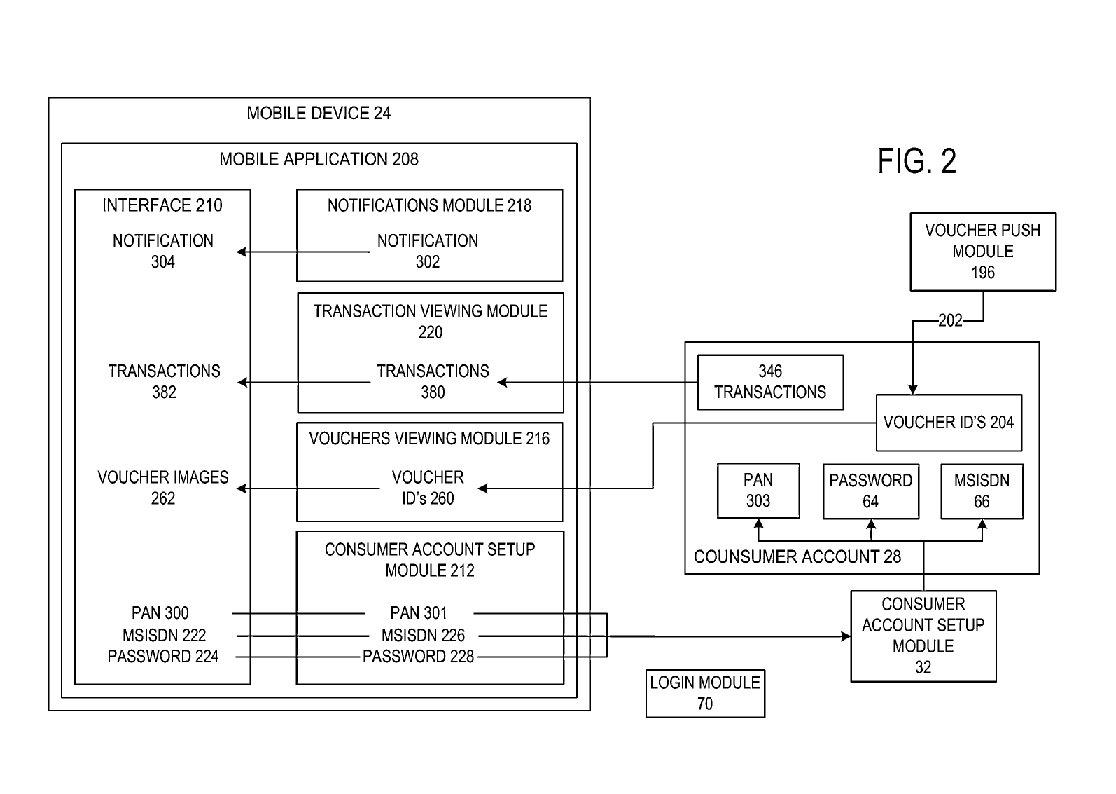

As shown in FIG. 2, the mobile device 24 includes a mobile application 208. The mobile application 208 has an interface 210, a consumer account setup module 212, a vouchers viewing module 216, a notifications module 218, and a transaction viewing module 220.

### 2). Consumer Accounts

When the mobile application 208 is initially downloaded onto the mobile device 24, a consumer is provided access to the consumer account setup module 212. The consumer can enter a Mobile Subscriber Integrated Services Digital Network Number (MSISDN) 222, a password 224 and a 16 digit primary account number (PAN) 300 into the interface 210. The MSISDN 222, the password 224 and PAN 300 are received as a MSISDN 226, a password 228 and a PAN 301 within the consumer account setup module 212 and are transmitted by the consumer account setup module 212 to the consumer account setup module 32.

The consumer account setup module 32 then establishes one consumer account 28 with a password 64 corresponding to the password 228, a MSISDN 66 corresponding to the MSISDN 226 and a PAN 303 corresponding to the PAN 301. The MSISDN 66 and the PAN 303 can either be a consumer account identifier for the respective consumer account 28. Each consumer account 28 will therefore have a different MSISDN 66 and PAN 303.

The system further includes a login module 70. A consumer at the mobile device 24 in FIG. 2 can enter a password and a MSISDN into the interface 210. The password and the MSISDN are transmitted from the mobile device 24 and are received by the login module 70. The login module 70 then compares the password with the password 64 of the consumer account 28 and compares the MSISDN with the MSISDN 66 of the consumer account 28. Upon a favorable comparison of the passwords and the MSISDN's, the login module 70 then authorizes access to the consumer account 28 having the respective MSISDN 66. The authorization is thus not provided to the mobile device 24 upon an unfavorable login through the login module 70.

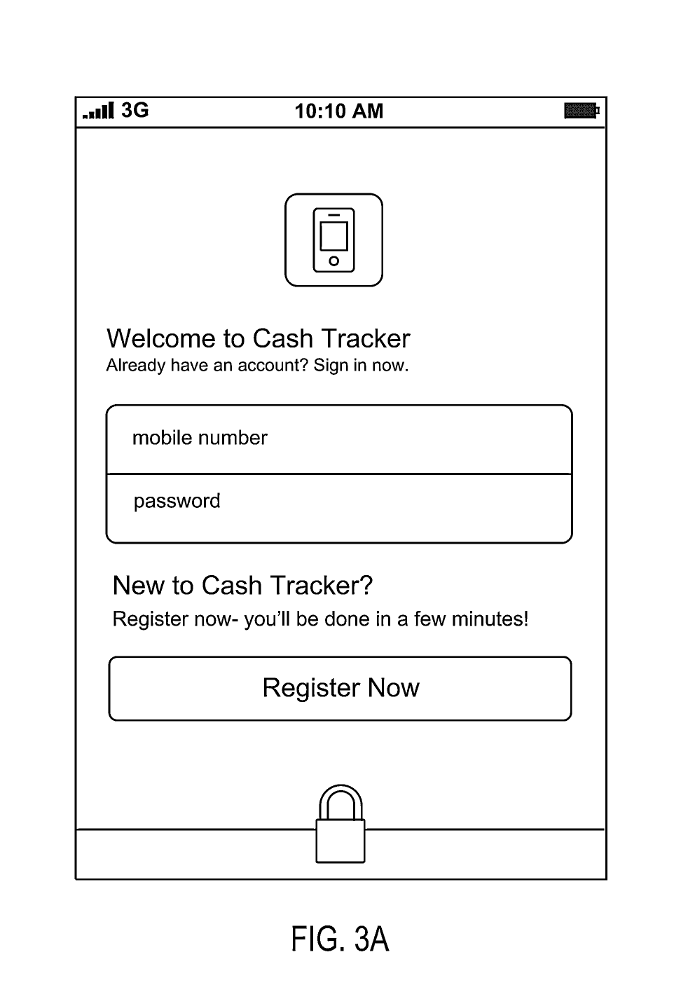

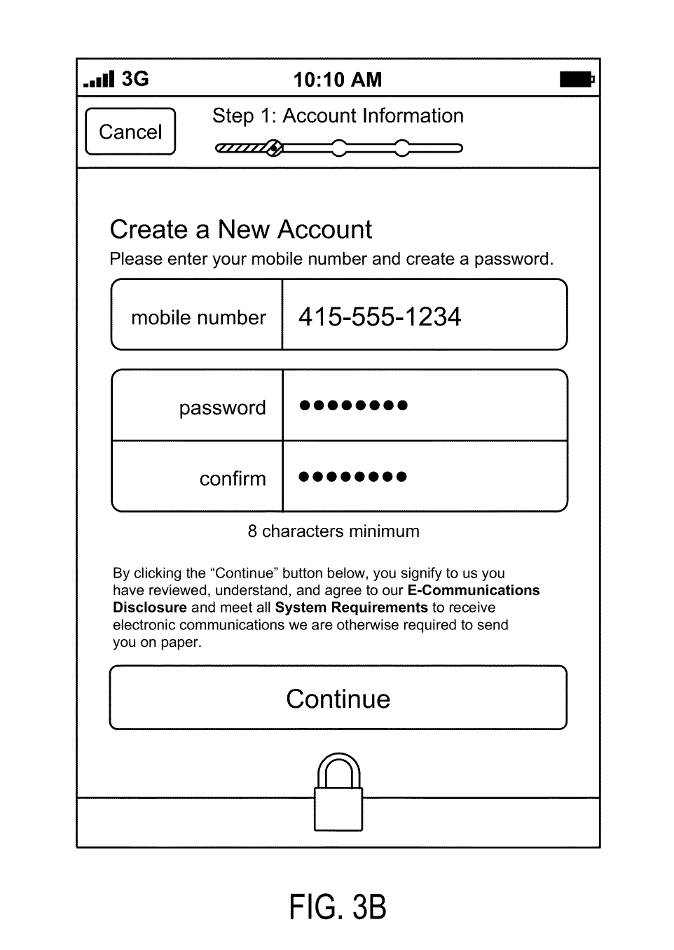

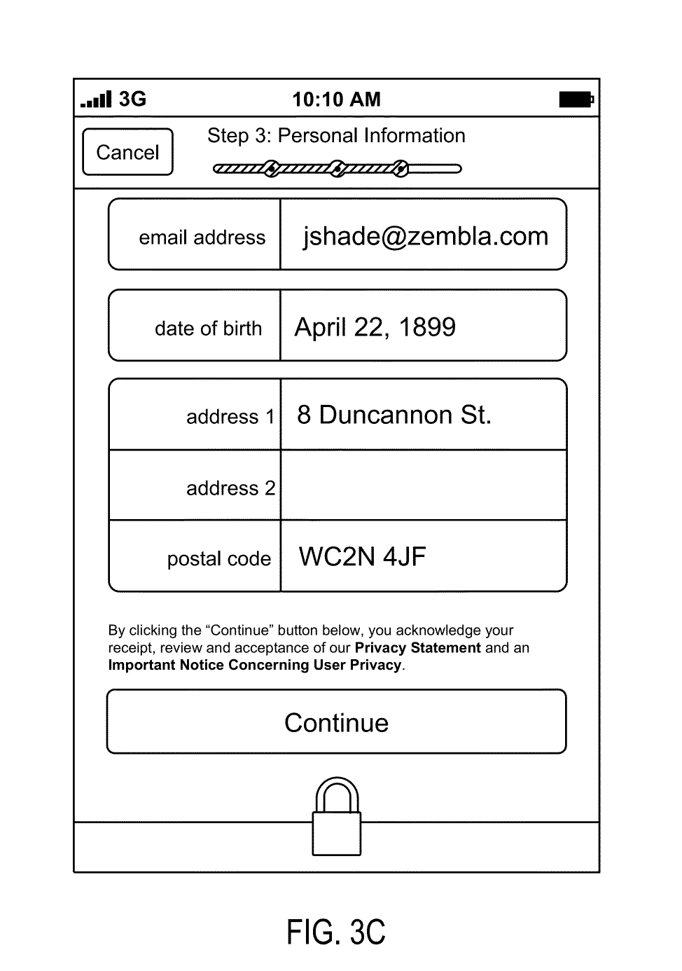

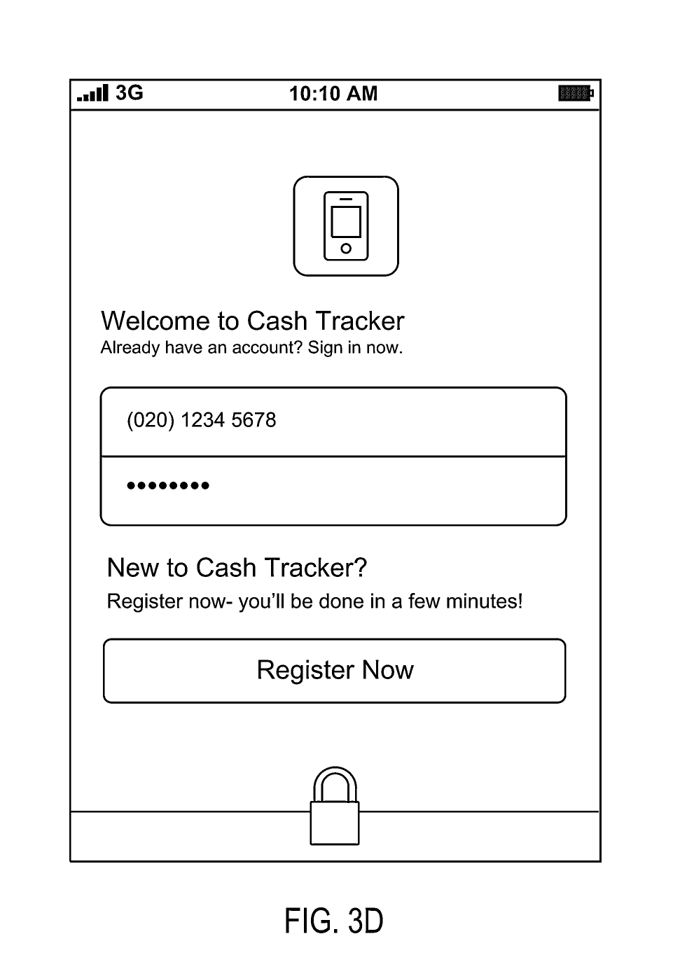

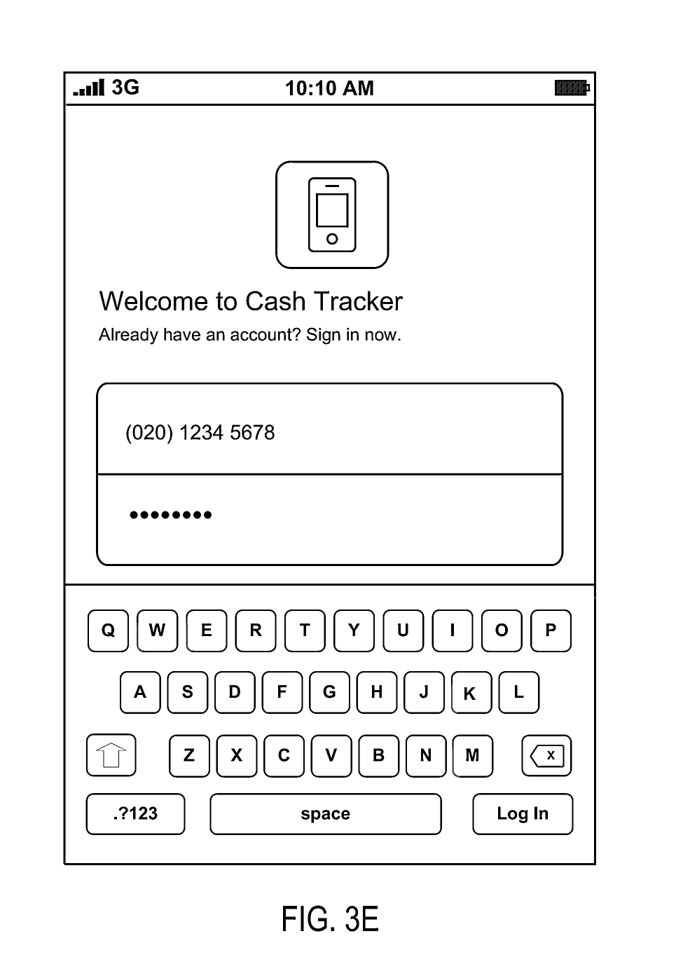

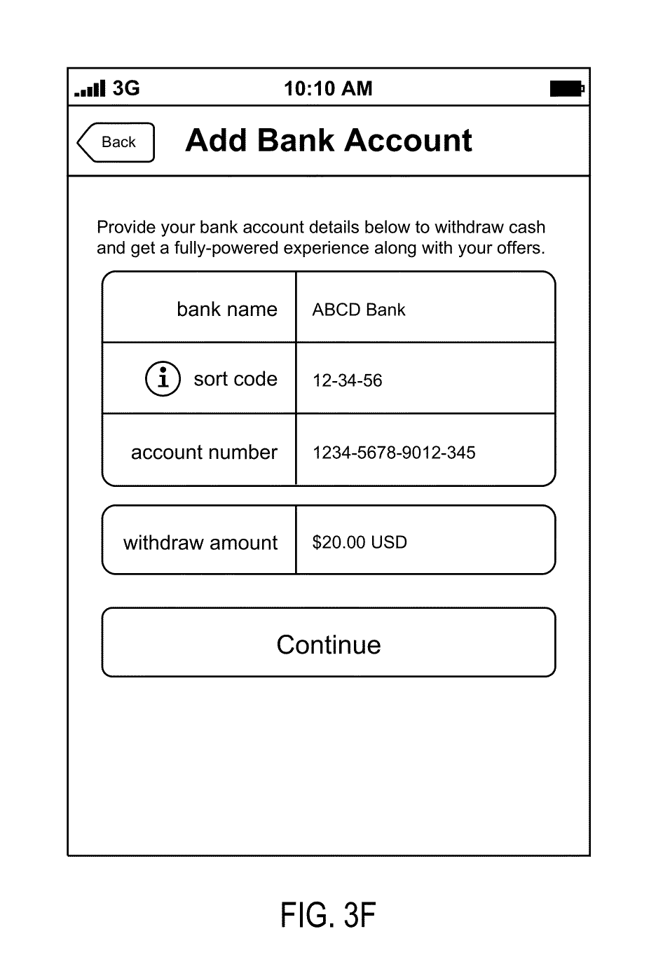

FIG. 3A illustrates a screenshot on the interface 210 in FIG. 2 when the consumer first opens the mobile application 208 and is given an option to either login or create a new account. FIG. 3B is a view similar to FIG. 3A when the consumer first establishes an account using the consumer account setup module 212 in FIG. 2. FIG. 3C is a view similar to FIG. 3B for the consumer to enter further details of the account.

FIGS. 3D and 3E are views that are displayed on the interface 210 in FIG. 2 when the consumer enters the password and the MSISDN in order to log into the respective consumer account 28.

FIG. 3F is a view that allows for the consumer to add a bank account and a PAN (account number) such as the PAN 300 in FIG. 2.

### 3). Merchant Offers

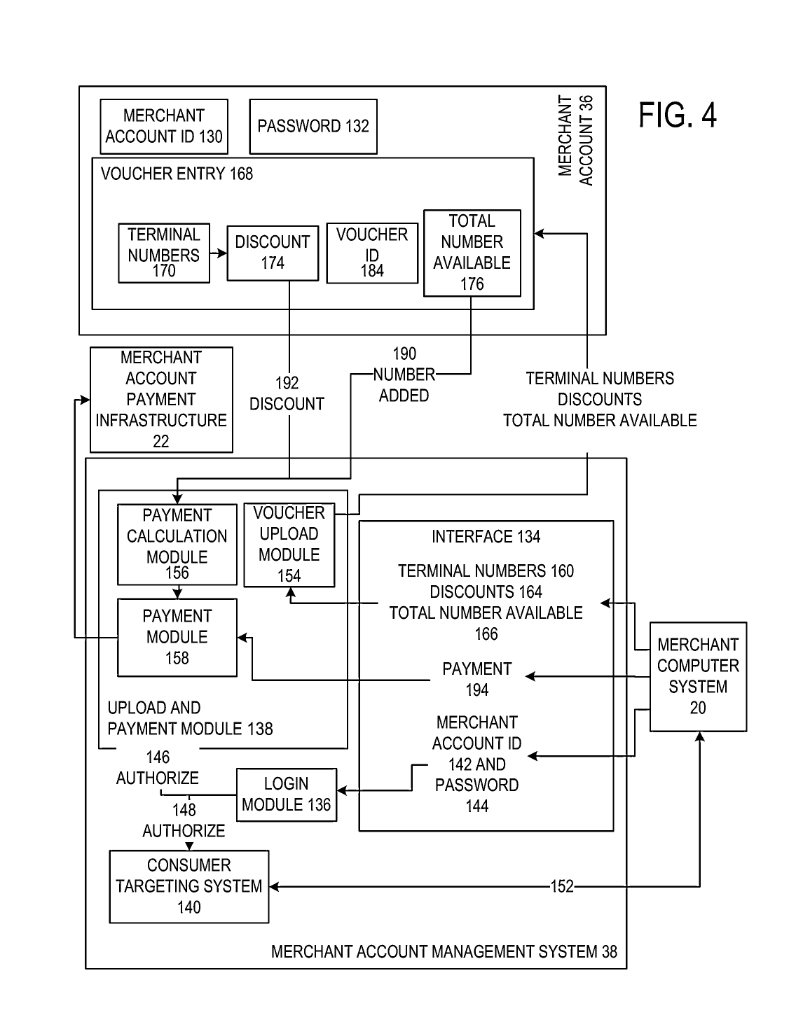

As shown in FIG. 4, the merchant account 36 in FIG. 1 is established by assigning a merchant account identifier (ID) 130 and a password 132. Each merchant account 36 will thus have a different merchant account ID 130.

The merchant account management system 38 includes an interface 134, a login module 136, an upload and payment module 138, and a consumer targeting system 140.

A merchant at the merchant computer system 20 can login to the merchant account 36 by downloading the interface 134 and entering a merchant account ID 142 and a password 144 via the interface 134 into the merchant account management system 38. The login module 136 then compares the merchant account ID 142 and the password 144 with the merchant account ID 130 and password 132 to identify and provide access to the respective merchant account 36. The login module 136 then at 146 authorizes access to the upload and payment module 138 by the merchant computer system 20 only for purposes of the respective merchant account 36 having the merchant account ID 130 matching the merchant account ID 142. At 148, the login module 136 similarly authorizes access to the consumer targeting system 140 by the merchant computer system 20.

The consumer targeting system 140 receives data from the consumer account 28 in FIG. 3 and all other consumer accounts. At 152, the merchant computer system 20 accesses the data received by the consumer targeting system 140. A merchant at the merchant computer system 20 can then selectively target a specific consumer account 28 or groups of consumer accounts based on the data received by the consumer targeting system 140. Table 1 illustrates selective targeting by select merchants.

TABLE 1

| | Merchant | Merchant | Merchant |
|---|---|---|---|
| | Account 1 | Account 2 | Account 3 |
| Consumer | Selective | No selective | Selective |
| Account 1 | targeting | targeting | targeting |
| Consumer | Selective | No selective | Selective |
| Account 2 | targeting | targeting | targeting |
| Consumer | Selective | No selective | Selective |
| Account 3 | targeting | targeting | targeting |

The upload and payment module 138 includes a voucher upload module 154, a payment calculation module 156, and a payment module 158. A merchant at the merchant computer system 20 uses the interface 134 to enter voucher information, including terminal numbers 160, discounts 164 and the total number available 166. The voucher upload module 154 then stores a respective voucher entry 168 in or associated with the merchant account 36 having the merchant account ID 130. The voucher entry 168 includes terminal numbers 170 corresponding to the terminal numbers 160, a discount 174 corresponding to one of the discounts 164, and a total number available 176 corresponding to the total number available 166. By way of example, the terminal numbers 170 may be terminals 2 and 5, the discount 174 may be 50 cents and the total number available 176 may be 60.

Similarly, additional voucher entries can be entered from the merchant computer system 20 through the interface 134 and the voucher upload module 154. Each voucher entry has a respective data set for terminal numbers 170, a discount 174 and the total number available 176. Each voucher entry also has a respective voucher ID 184.

Once the voucher entry 168 has been uploaded into the merchant account 36, the payment calculation module 156 calculates a payment to be made based on the voucher entry 168. In the example, it is assumed that the voucher entry 168 was pre-existing with a certain number, for example 20 as the total number available. The payment calculation module 156 at 190 receives or calculates the number added to the total number available 176. In the present example, the total number available 176 has increased from 20 to 60, such that the number added is 40. The payment calculation module 156 at 192 also receives the discount 174. The payment calculation module 156 then multiplies the number added by the discount 174. In the present example, the number added is 40 and the discount is 50 cents, which results in a payment of $20.

The payment calculation module 156 then submits the $20 charge to the payment module 158. The merchant then enters a payment 194 into the interface 134, which is received by the payment module 158. The payment module 158 communicates with the merchant account payment infrastructure 22 by submitting a charge request and receiving a confirmation to either allow or deny the charge request. In another example, the merchant account 36 may have a stored value 96 that can be updated from a funding source and the payment module 158 can decrement the stored value 96 by entering a debit against the stored value 96.

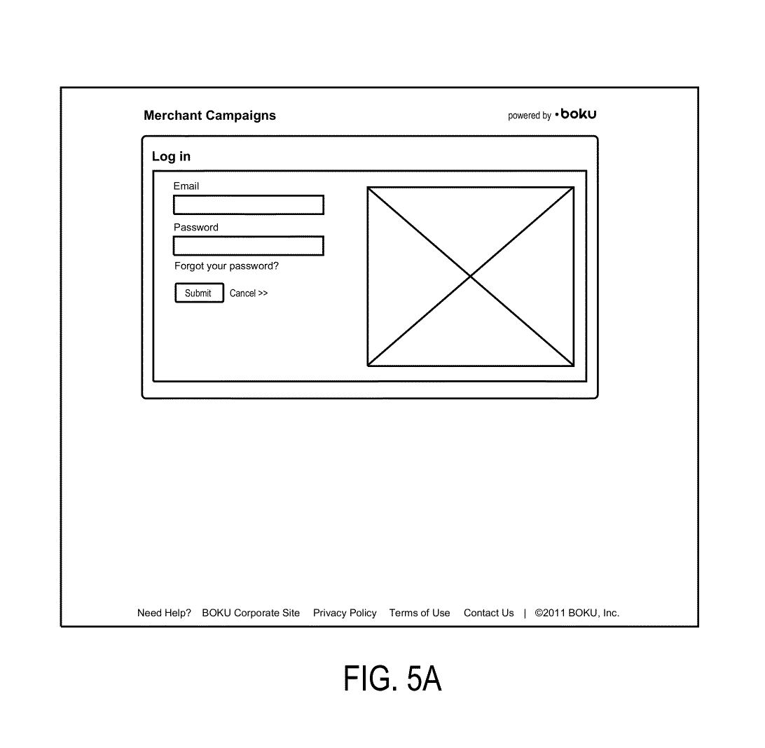

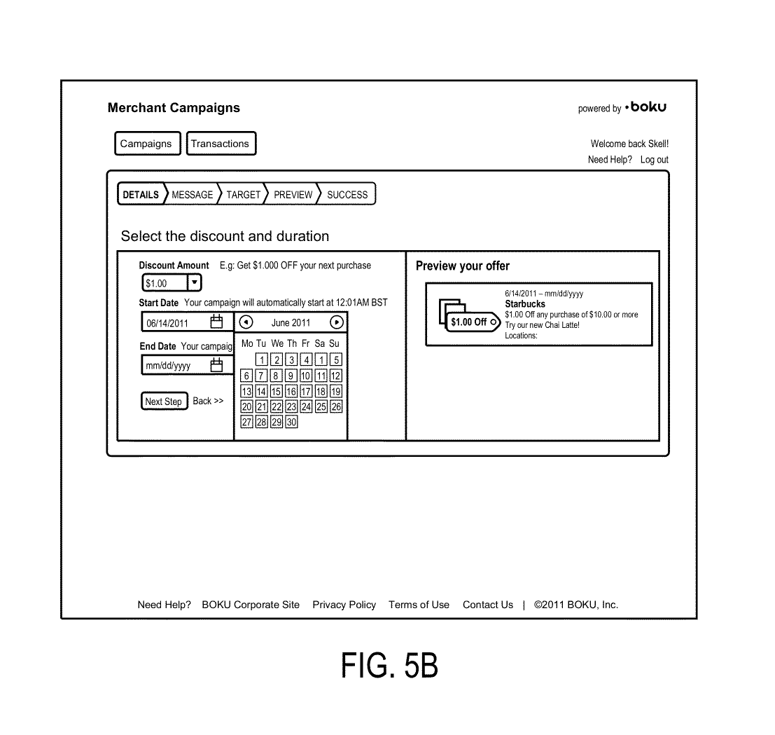

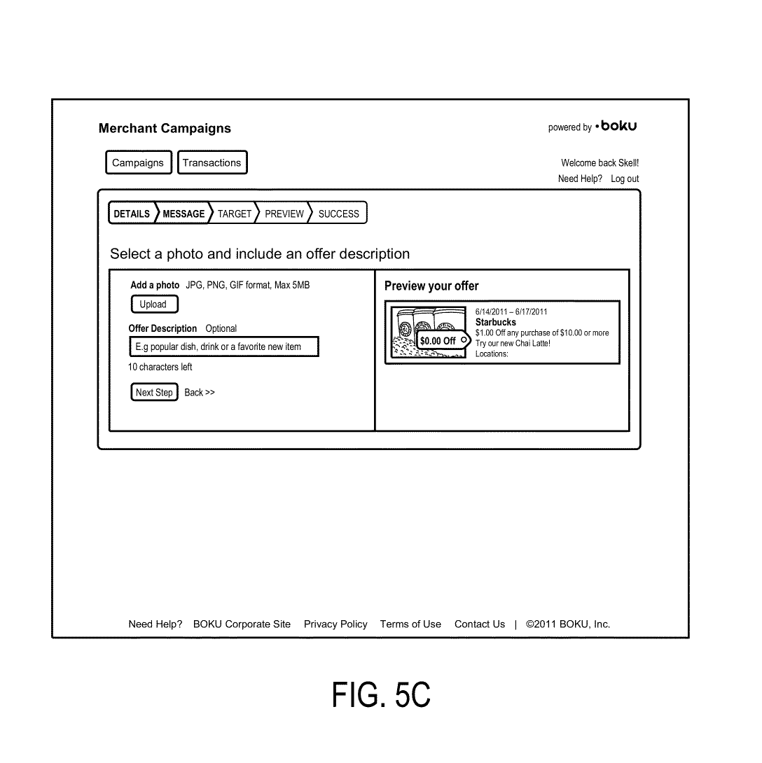

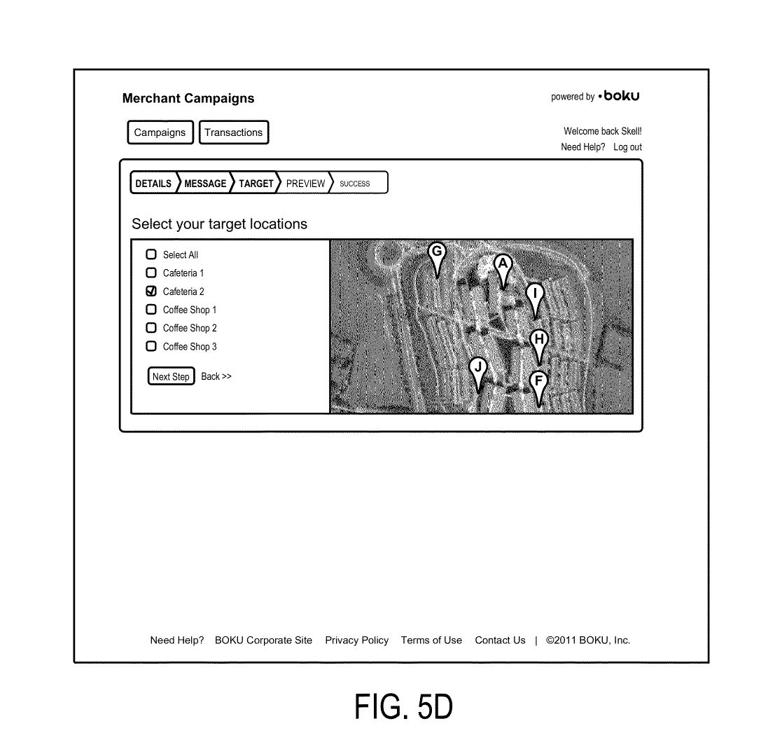

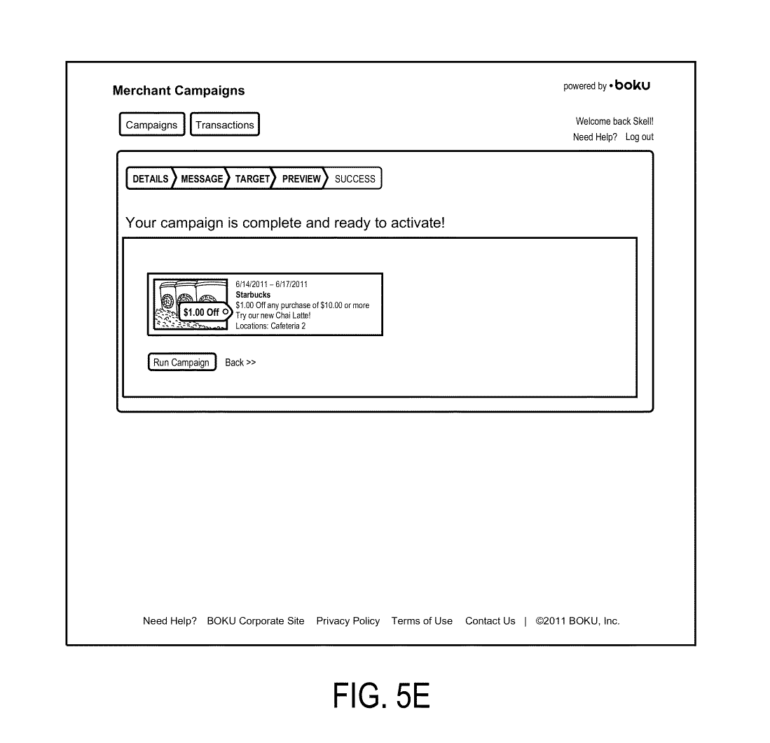

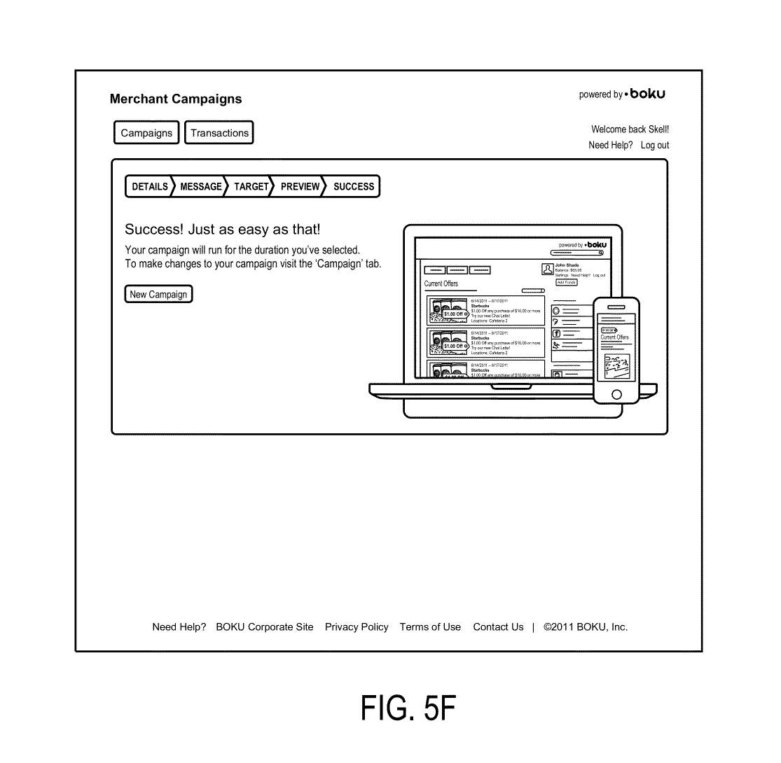

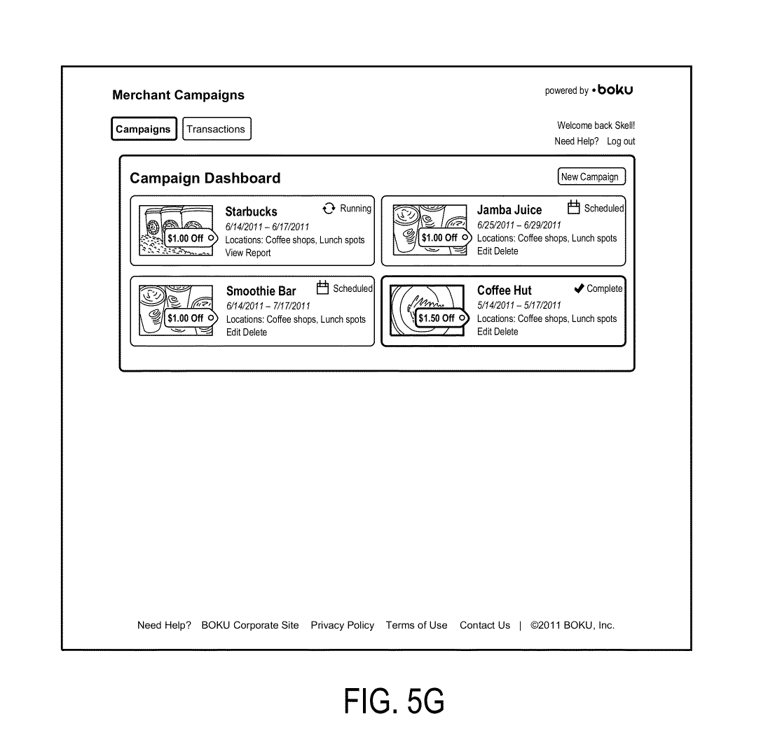

FIG. 5A illustrates a screenshot that appears in the interface 134 when viewed within a browser window of a browser application at the merchant computer system 20 in FIG. 4. The merchant logs in using an email and a password.

FIG. 5B illustrates a screenshot that is displayed at the merchant computer system 20 after login and when a merchant begins to enter details of an offer. The interface 134 allows for entry of a discount (“Discount Amount”) and start and end dates of the offer. A preview of the offer is also displayed.

In FIG. 5C the merchant is given an opportunity to upload a photo or other image of the offer. The photo or image will then be displayed within the respective voucher entry, e.g. the voucher entry 168 in FIG. 4. The photo or image can be uploaded from the merchant computer system 20 or from another location on a network.

In FIG. 5D the merchant is given an opportunity to restrict the offer to certain locations, while excluding other locations.

In FIG. 5E the merchant is given an opportunity to preview the offer as it will appear before approving the offer. The merchant then selects a button “Run Campaign” to approve the offer.

FIG. 5F is a screenshot displaying to the merchant that the offer is successful. The consumer can then select a button “Campaigns.”

FIG. 5G illustrates a screenshot that is subsequently displayed to the merchant, illustrating the offer that has just been approved by the merchant and all other offers that are scheduled, completed or presently running based on the respective merchant account having the merchant account ID 130 in FIG. 4.

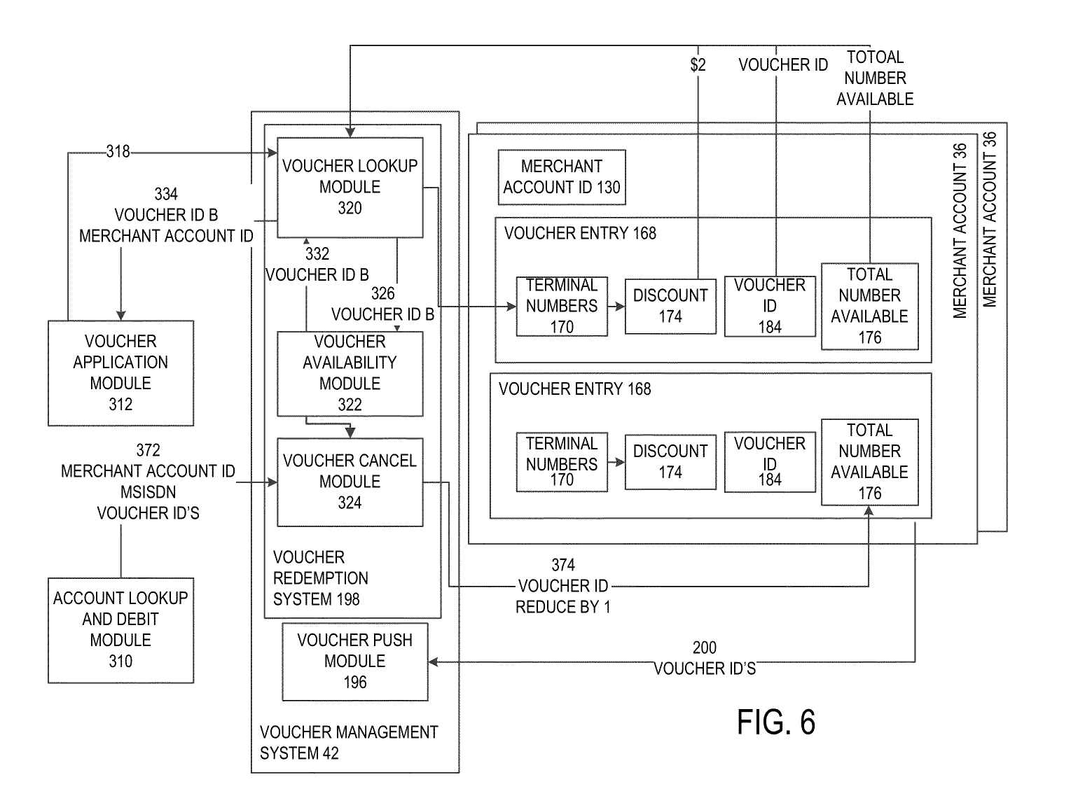

As shown in FIG. 6, the voucher management system 42 includes a voucher push module 196 and a voucher redemption system 198.

The voucher push module 196 at 200 receives all the voucher ID's 184 of the voucher entries. Referring again to FIG. 2, the voucher push module 196 at 202 then enters the voucher ID's 184 as voucher ID's 204 in the consumer account 28 and all other consumer accounts that have been targeted by a merchant. As such, merchant offers in the form of voucher ID's are associated with one of the consumer accounts 28 having a MSISDN 66 or PAN 303 as a consumer account ID.

The merchant offers in the form of the voucher ID's 204 can then be further processed based on the association of the voucher ID's 204 with the MSISDN 66 of the respective consumer account 28. In particular, the voucher ID's 204 can be transmitted to a mobile device 24 and be received by a mobile application that has been logged into the respective consumer account 28 by way of an identifier of the consumer account 28 having the MSISDN 66 as a consumer account identifier. Following login of the mobile application 208 into the consumer account 28, the vouchers viewing module 216 is accessible by a consumer operating the mobile device 24. The consumer then directs the vouchers viewing module 216 to download the voucher ID's 204 from the consumer account 28 as voucher ID's 260 received by the vouchers viewing module 216. Each voucher ID 260 has an associated image and the images are collectively displayed as voucher images 262 within the interface 210. Each voucher entry 168 within the merchant account 36 of FIG. 4 may for example have a respective voucher image and the voucher images are separately downloaded by the vouchers viewing module 216 of FIG. 2 based on the voucher ID's 260. What is important to note however, is that the voucher ID's 260 and the voucher images 262 are transmitted by the server computer system 12 in FIG. 1 and are received by the mobile device 24 based on a matching of the MSISDN transmitted by the mobile application 208 during login and the MSISDN 66 of the respective consumer account 28.

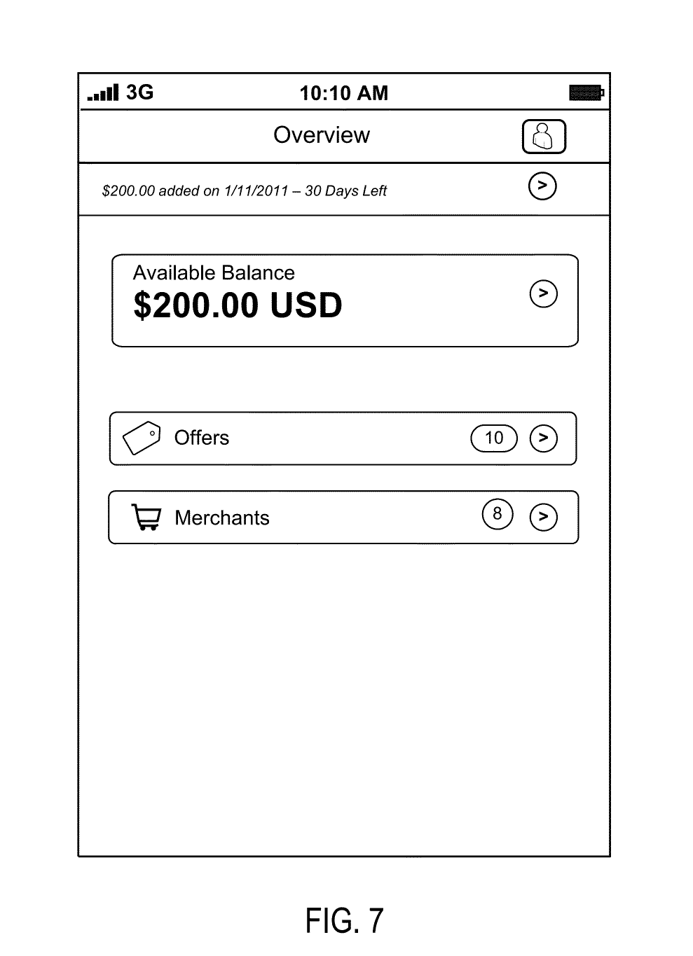

FIG. 7 is a home screen after login of the mobile application 208 in FIG. 2 where a balance is displayed. The home screen also includes links for viewing offers and merchants. The balance shown in the view of FIG. 7 may be received or “sniffed” from an issuer or credit card computer system using a separate module, not shown.

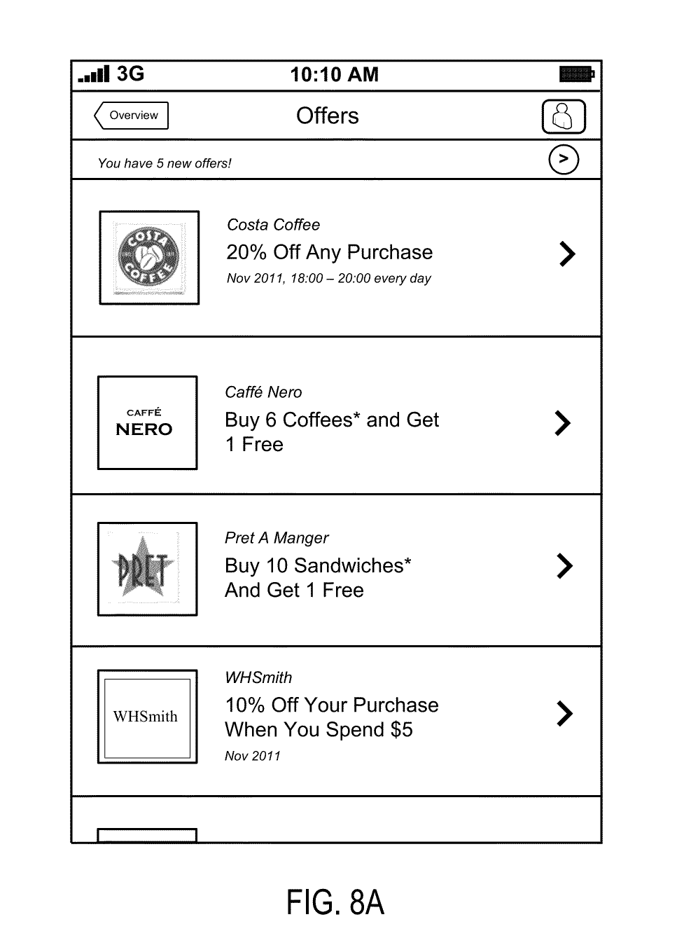

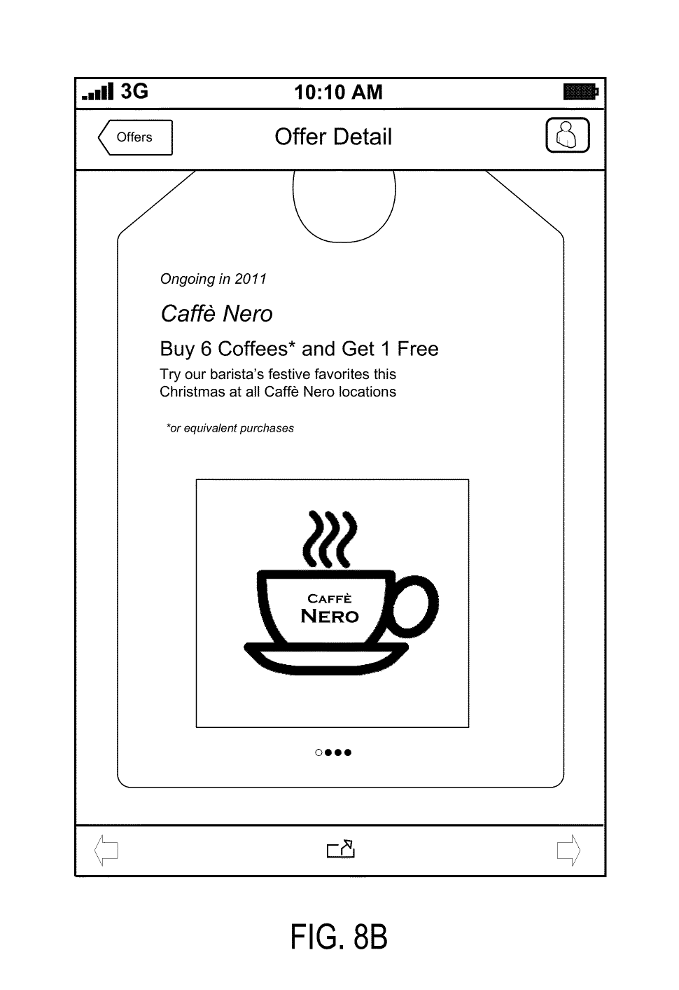

FIG. 8A illustrates a plurality of voucher images such as the voucher images 262 in FIG. 2 that are displayed after the consumer selects “Offer” in FIG. 7. The consumer can select any one of the vouchers to obtain more information about the voucher and the offer.

FIG. 8B is a view that is displayed showing more information about one of the vouchers.

### 4). Transaction Processing

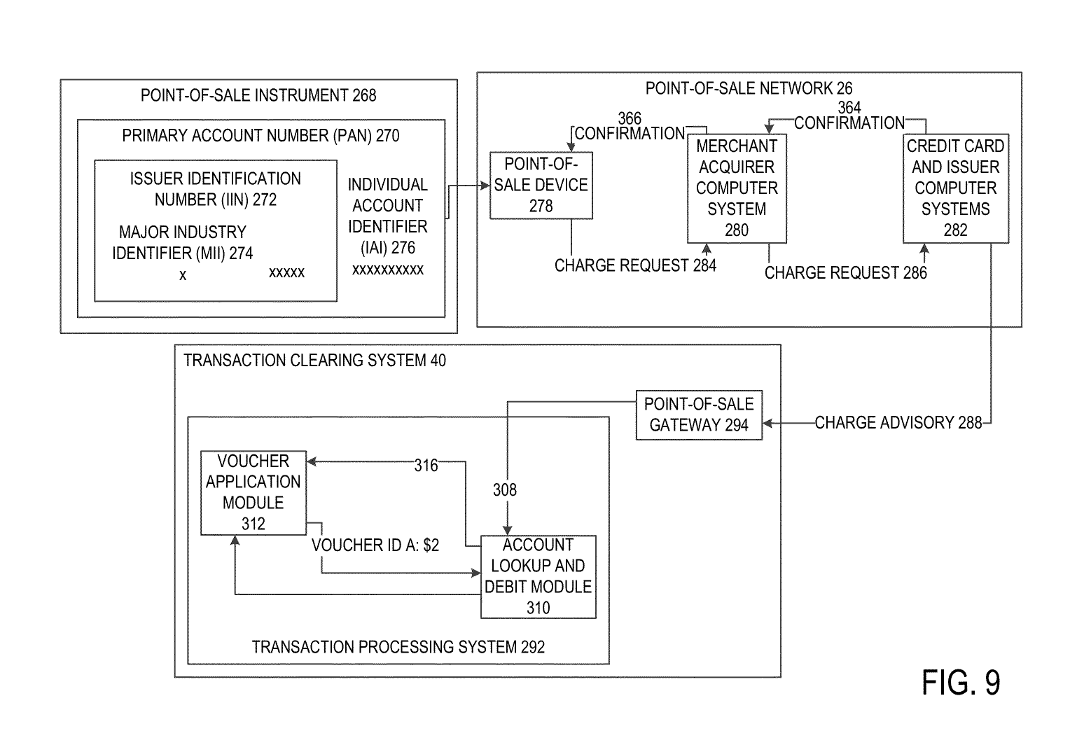

Referring to FIG. 9, the consumer uses a single point-of-sale instrument 268 to pay for an item that the consumer wishes to purchase. The point-of-sale instrument 268 may for example be a credit card, a bank card or a Near Field Communication (NFC) device. The point-of-sale instrument 268 includes a single 16 digit PAN 270. The first six digits of the PAN 270 are an issuer identification number (IIN) 272. The first digit of the IIN 272 is a major industry identifier (MII) 274. The last ten digits of the PAN 270 comprise an individual account identifier (IAI) 276.

The point-of-sale network 26 includes a point-of-sale device 278, a merchant acquirer computer system 280, and a credit card and issuer computer systems 282.

The consumer uses the point-of-sale instrument 268 to communicate with the point-of-sale device 278. The point-of-sale device 278 receives the PAN 270 from the point-of-sale instrument 268. In the case where the point-of-sale instrument 268 is a credit card or a bank card, the PAN 270 is located on a magnetic strip and the point-of-sale device 278 is a device that has a magnetic strip reader. In the example where the point-of-sale instrument 268 is an NFC device, the point-of-sale device 278 communicates with the point-of-sale instrument 268 through electromagnetic waves to receive the PAN 270.

The point-of-sale device 278 transmits a charge request 284 to the merchant acquirer computer system 280. The charge request 284 includes the PAN 270, the terminal number of the point-of-sale device 278 and the total price of all the items.

The merchant acquirer computer system 280 then transmits a charge request 286 to the credit card and issuer computer systems 282. The charge request 286 includes the same data as the charge request 284. Although not shown, the charge request 286 also includes a merchant account ID to determine a merchant account 36 to which the point-of-sale device 278 belongs to. The charge request 286 also includes a merchant category code that is provided by the merchant acquirer computer system 280. Different merchant category codes are used for different merchant types, e.g. apparel, restaurant, groceries etc. The point-of-sale network 26 has a number of different credit card and issuer computer systems 282 and the merchant acquirer computer system 280 utilizes the IIN 272 to route the charge request 286 to the appropriate credit card and issuer computer systems 282. The credit card and issuer computer systems 282 then check a stored value for the PAN 270 and transmit a confirmation 364 if the stored value is at least as much as the amount of the charge request 286. If the stored value is less than the amount in the charge request 286, a decline signal is transmitted instead of the confirmation 364. The merchant acquirer computer system 280 receives the confirmation 364 (or decline signal) and transmits a confirmation 366 (or decline signal) to the point-of-sale device 278.

The credit card and issuer computer systems 282 then transmit a charge advisory 288 to the transaction clearing system 40 after sending the confirmation 364. The charge advisory 288 includes the same data as the charge request 286. The credit card and issuer computer systems 282 utilize the PAN 270 to route the charge advisory 288 to the transaction clearing system 40.

The transaction clearing system 40 includes a point-of-sale gateway 294 and a transaction processing system 292. The point-of-sale gateway 294 receives the charge advisory 288 from the credit card and issuer computer systems 282.

At 308, the point-of-sale gateway 294 provides a data set to the transaction processing system 292, including the PAN 270, the terminal number, the amount, and the respective merchant account ID received in the charge advisory 288.

The transaction processing system 292 includes an account lookup and debit module 310 and a voucher application module 312.

The account lookup and debit module 310 receives the data set provided at 308 from the point-of-sale gateway 294. At 316, the account lookup and debit module 310 provides a data set to the voucher application module 312, including the PAN terminal number, amount and merchant account ID. Referring again to FIG. 6, at 318 the voucher application module 312 provides a data set to the voucher management system 42 corresponding to the data set received from the account lookup and debit module 310 at 316. The purpose of the voucher application module 312 is to determine if, and if so, which voucher discounts may apply to the items identified in the data set received at 316. The voucher redemption system 198 includes a voucher lookup module 320, a voucher availability module 322 and a voucher cancel module 324.

The voucher lookup module 320 receives the data transmitted at 318 from the voucher application module 312. The voucher lookup module 320 then uses the data received at 318 to determine whether the data matches the data in the voucher entries 168. In each case, both the merchant account ID and the terminal number received in the data 318 are used to determine which ones of the voucher entries 168 have merchant account ID's 130 and matching terminal numbers 170.

The voucher lookup module 320 subsequently retrieves a set of data from an identified voucher entry 168, including the discount 174, in the present example $2, the voucher ID 184 and the total number available 176. The voucher lookup module 320 then makes a determination whether the total number available 176 of the respective voucher entry 168 is more than zero, in which case and only in that case, is the voucher entry 168 still valid. The voucher lookup module 320 also retrieves the merchant account ID 130. For purposes of further discussion, the voucher ID 184 of the identified voucher entry 168 is still valid and referred to herein as “voucher ID B.”

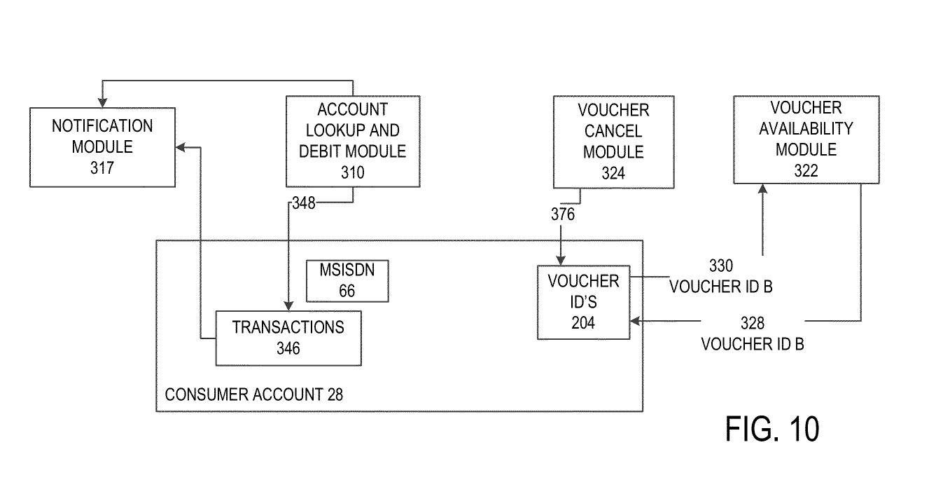

The voucher lookup module 320 at 326 submits the voucher ID of the identified voucher entry 168, now referred to as “voucher ID B” to the voucher availability module 322. Referring now to FIG. 10, the voucher availability module 322 at 328 determines whether voucher ID B is still valid within the voucher ID's 204 of the respective consumer account 28. Voucher ID B may for example not be valid, either because it has previously been used or the particular consumer account 28 having the MSISDN 66 has not been targeted by a merchant. In the present example, voucher ID B is found within the voucher ID's 204 and is determined to be valid. At 330, voucher ID B that is determined to be valid is returned to the voucher availability module 322.

Referring again to FIG. 6, the voucher lookup module 320 retrieves voucher ID B from the voucher availability module 322 because it is valid. At 334 the voucher lookup module 320 submits the voucher ID B together with its associated discount, in the present example $2, in a data set to the voucher application module 312. The data set received at 334 by the voucher application module 312 also includes the respective merchant account ID 130 retrieved by the voucher lookup module 320.

Referring again to FIG. 10, at 348, the account lookup and debit module 310 utilizes the PAN received at 308 to identify the respective consumer account 28 having a MSISDN 66 matching the MSISDN received at 308. The consumer account 28 also has a set of previous transactions 346. At 348, the account lookup and debit module 310 records the respective transaction within the transactions 346.

The voucher cancel module 324 proceeds at 376 to cancel the respective voucher ID's from the voucher ID's 204 in the consumer account 28. In one example, there may be only one voucher ID B among the voucher ID's 204 and only the single voucher ID B is cancelled. In another example, the voucher ID may have two or more numbers associated therewith, and only a single number is deducted from the numbers for voucher ID B, such that further numbers of the voucher ID are available until the number reaches zero. As further illustrated in FIG. 6, the voucher cancel module 324 at 374 reduces the respective number within the total number available 176 of the respective voucher entry 168.

As mentioned, the transaction is recorded within the transactions 346. Referring again to FIG. 2, the transaction viewing module 220 downloads the transactions 346 of FIG. 10 as transactions 380 and displays the transactions 380 as transactions 382 within the interface 210.

Voucher entries have been used by way of example to illustrate offers and the way that they are redeemed. The voucher entries may for example correspond to item level discounts. Alternatively, basket level discounts may be provided wherein a discount is given based on an entire purchase of a plurality of items as opposed to individual items of the purchase. It may also be possible that offers may be extended that are not redeemable at server level for any discounts, such as coupons that can be redeemed at a point of sale or advertisements.

As further illustrated in FIG. 10, the account lookup and debit module 310 initiates action by a notification module 317 to transmit an Short Message Service (SMS) message to the mobile device 24 in FIG. 2. The mobile device 24 includes a notifications module 317 that receives the notification as a notification 302. The notification 302 received by the notifications module 317 is displayed as a notification 304 within the interface 210.

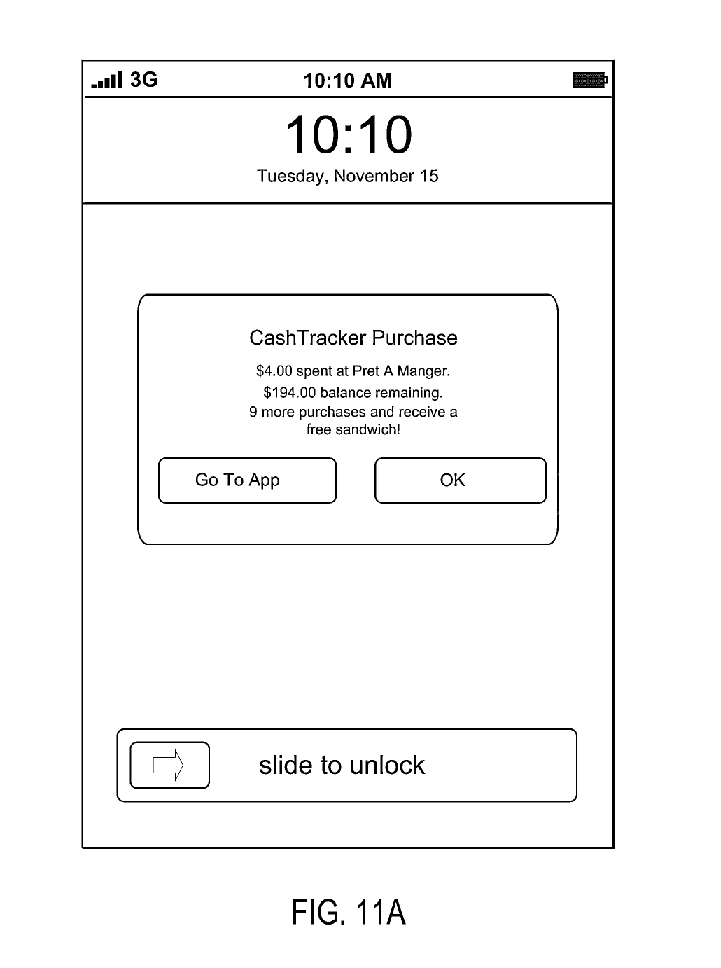

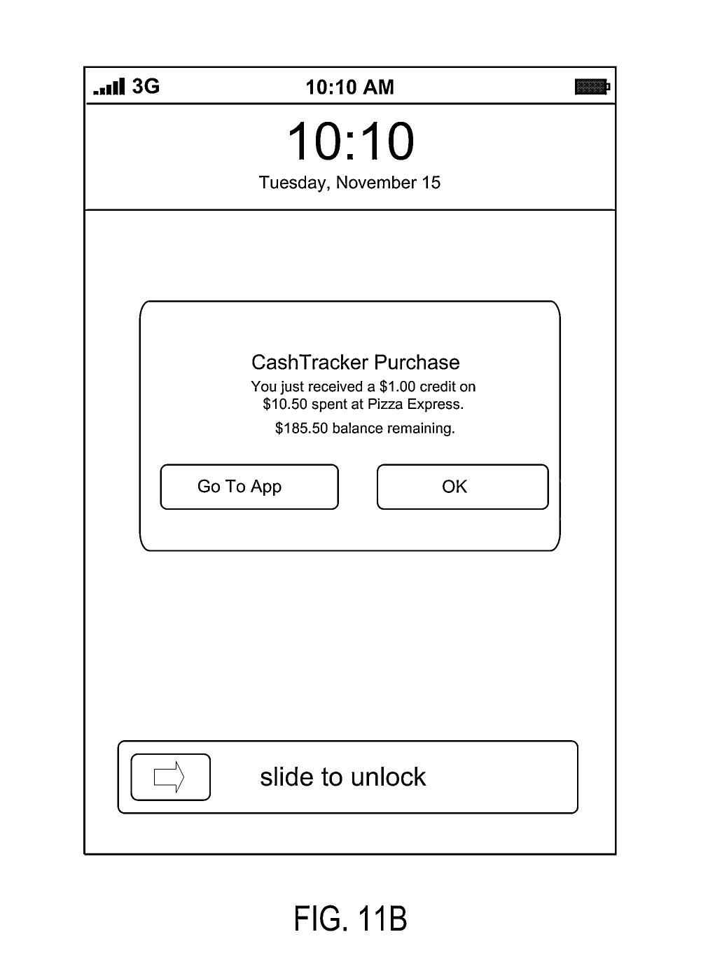

In FIG. 11A, a notification 304 is received and displayed to the consumer indicating a charge of $4.00, bringing a stored value held by an issuer computer system to a balance of $194.00. The stored value held with the issuer computer system however remains at $200 and is only reduced during later settlement. The notification 304 also indicates text displayed to the consumer indicating that nine more purchases will result in a discount for a free sandwich. In FIG. 11B, a notification 304 is received and displayed to the consumer, indicating a charge of $10.50 and that a credit of $1.00 has been applied to bring the balance of the stored value to $185.50.

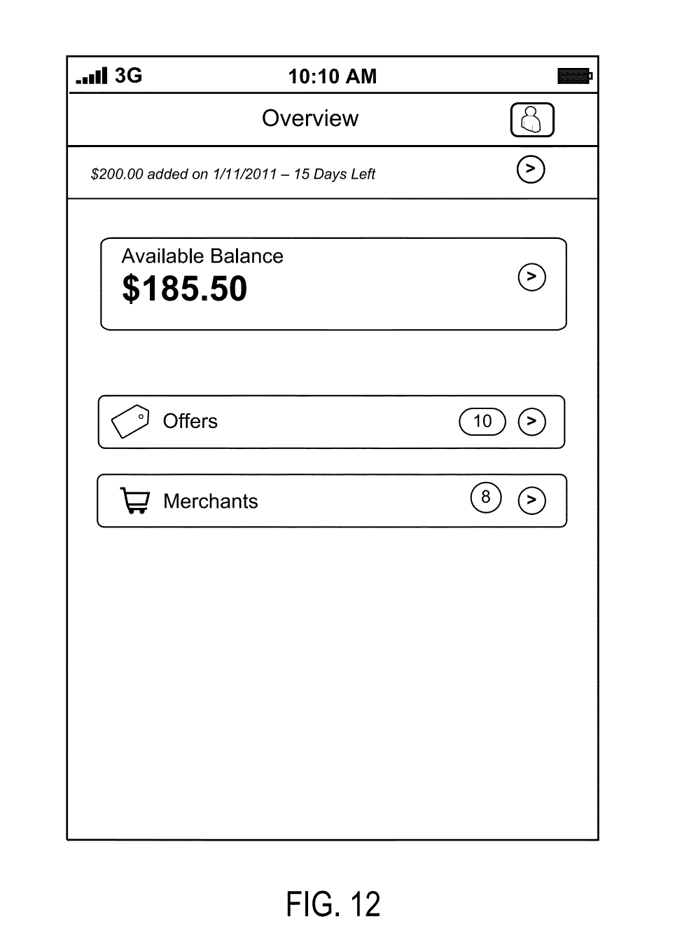

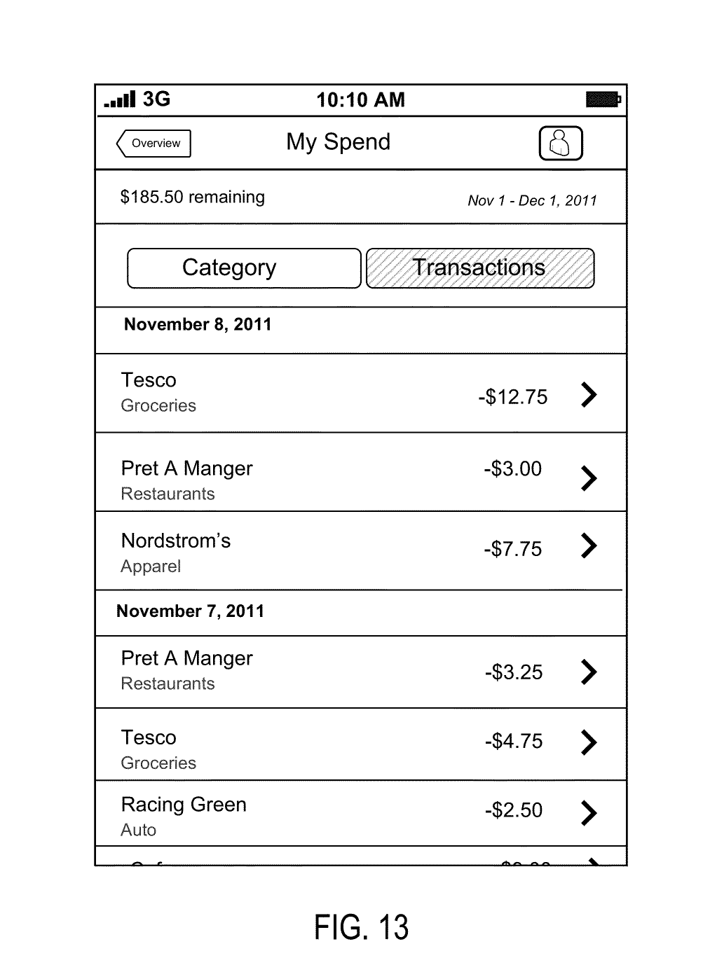

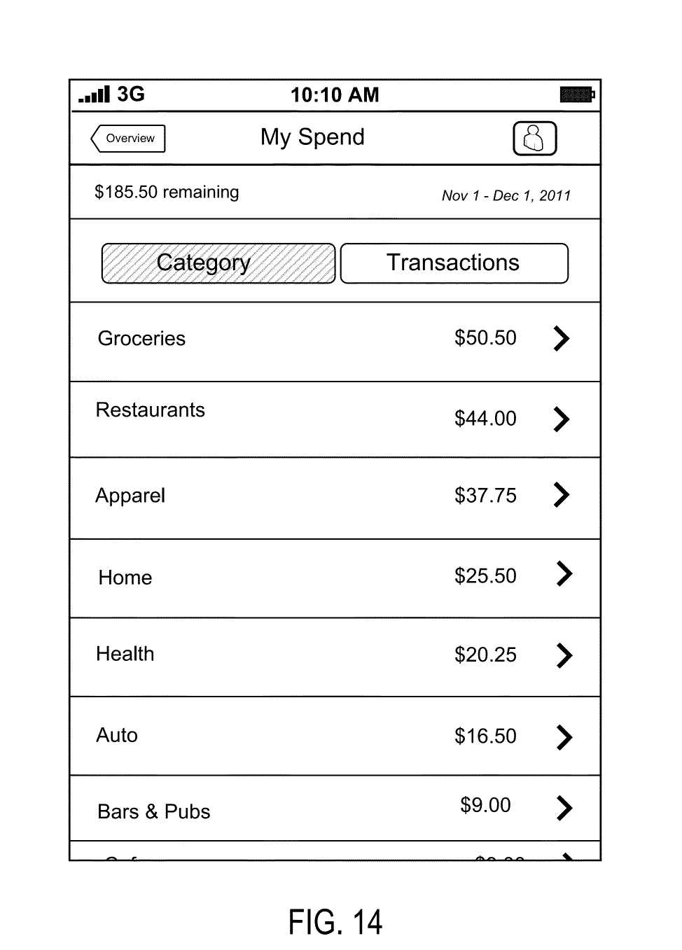

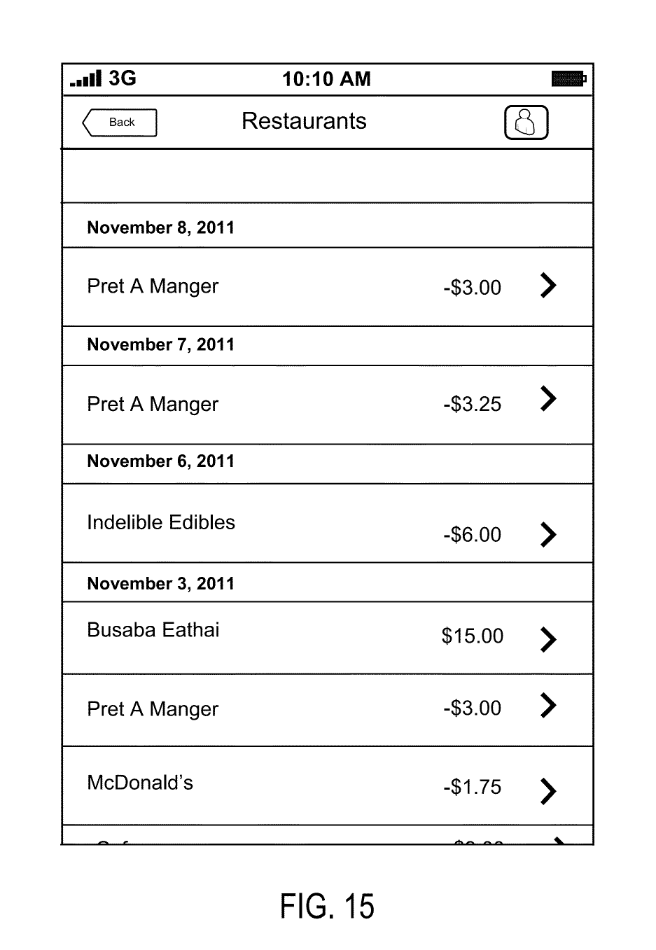

Should the consumer then open the mobile application 208 in FIG. 2, a view such as in FIG. 12 is displayed to the consumer. The view in FIG. 12 includes the balance of the stored value of $185.50 and also links to Offers and Merchants. The stored value held at the issuer computer system is however still $200 until later settlement. Selecting the link next to the Available Balance, will take the consumer to the view of FIG. 13 wherein details of all transactions are displayed. The transactions displayed in FIG. 13 thus correspond to the transactions 382 in FIG. 2. FIG. 13 also provides a link for the consumer to view categories of transactions. Should the consumer select the link for categories, a view such as in FIG. 14 is displayed to the consumer. Should the consumer then select one of the categories, for example the category for “Restaurants”, a view such as in FIG. 15 is displayed. In FIG. 15, transactions categorized as “Restaurants” are displayed to the consumer.

### 5). Settlement

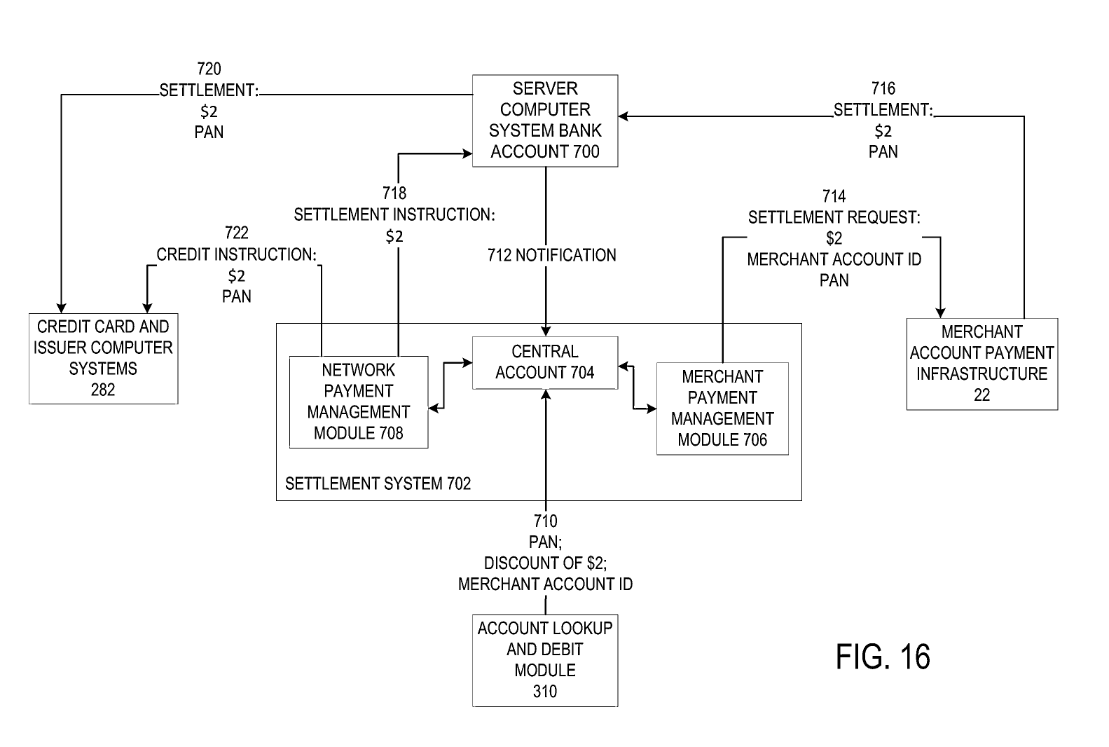

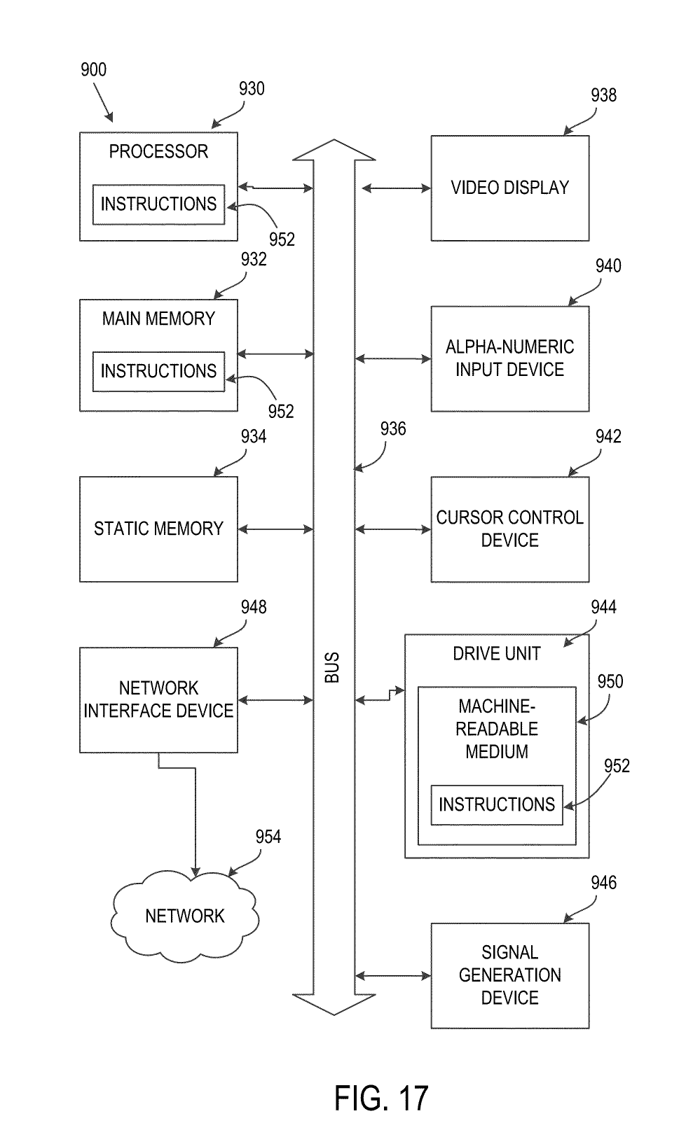

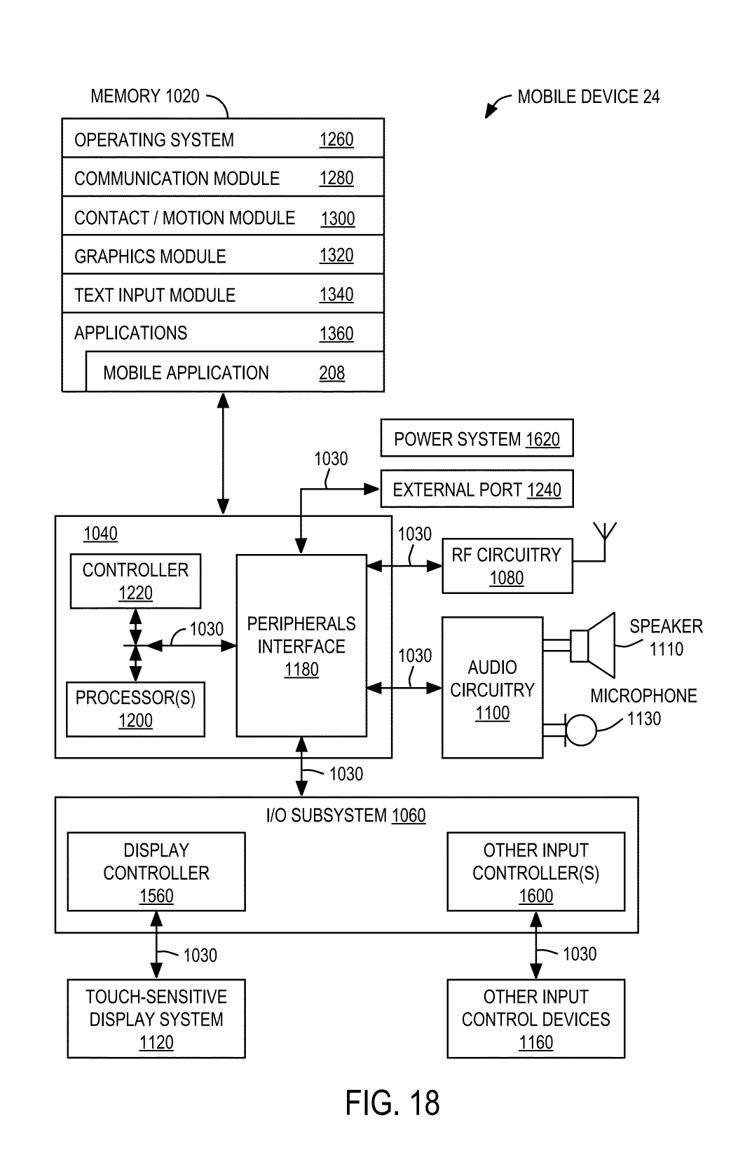

As further illustrated in FIG. 1, the transactions network 10 further includes a server computer system bank account 700 and the server computer system 12 includes a settlement system 702. As shown in FIG. 16, the settlement system 702 includes a central account 704, a merchant payment management module 706 and a network payment management module 708. The central account 704 is connected to the account lookup and debit module 310, server computer system bank account 700, merchant payment management module 706 and network payment management module 708. The central account 704 can receive an update 710 from the account lookup and debit module 310, a notification 712 from the server computer bank account 700. The merchant payment management module 706 communicates bidirectionally with the central account 704 and the network payment management module 708 communicates bidirectionally with the central account 704.

The merchant payment management module 706 is also connected to the merchant account payment infrastructure 22 for purposes of transmitting a settlement request 714 to the merchant account payment infrastructure 22. The merchant account payment infrastructure 22 is also connected to the server computer system bank account 700 for purposes of transmitting a settlement 716 to the server computer system bank account 700.

The network payment management module 708 is connected to the server computer system bank account 700 for purposes of transmitting a settlement instruction 718 to the server computer system bank account 700. The server computer system bank account 700 is also connected to the credit card and issuer computer systems 282 for purposes of transmitting a settlement 720 to the credit card and issuer computer systems 282.

In use, the account lookup and debit module 310 at 710 enters the amount of the voucher that has been applied using the voucher application module 312 of FIG. 6 as an entry into the central account 704. The entry includes an account identifier at the credit card and issuer computer systems 282 in the form of the PAN that has been received from the credit card and issuer computer systems 282, the discount amount of $2 of the respective voucher, and the merchant account ID that has been received from the credit card and issuer computer systems 282.

The merchant payment management module 706 periodically accesses the central account 704 and retrieves the entry. The merchant payment management module 706 then utilizes the merchant account ID to identify the respective merchant account payment infrastructure 22 from which payment should be collected. At 714, the merchant payment management module 706 transmits the settlement request to the merchant account payment infrastructure 22. The merchant payment management module 706 updates the central account 704 with a flag to indicate that the settlement request 714 has been sent. The settlement request 714 includes a request for a settlement of $2 and the merchant account ID. The merchant account payment infrastructure 22 then utilizes the merchant account ID to identify a respective account within the merchant account payment infrastructure 22. At 716, the merchant account payment infrastructure 22 transfers an amount of $2 from the respective account that has been identified within the merchant account payment infrastructure 22 to the server computer system bank account 700.

When the server computer system bank account 700 receives the settlement 716 or shortly thereafter, the server computer system bank account 700 sends the notification 712 to the central account 704. The entry in the central account 704 is then updated with a tag to indicate that $2 has been received by the server computer system bank account 700 from the merchant account payment infrastructure 22. The electronic funds corresponding to the $2 is thus held in the server computer system bank account 700 and not in the central account 704 and the central account 704 is only updated to reflect the funds that have been received by the server computer system bank account 700. The central account 704 thus “shadows” the funds in the server computer system bank account 700.

The network payment management module 708 periodically accesses the central account 704 to determine whether any entries have been flagged that ones have been received by the server computer system bank account 700 and have not been flagged that the network payment management module 708 has transmitted a settlement instruction to the server computer system bank account 700. In the present example the entry for the discount of $2 has been flagged that funds have been received by the server computer system bank account 700. The network payment management module 708 then transmits the settlement instruction 718 to the server computer system bank account 700. The settlement instruction 718 includes an instruction for settlement of $2. The settlement instruction 718 may also include a routing number for the credit card and issuer computer systems 282. When the network payment management module 708 has transmitted the settlement instruction 718, the network payment management module 708 updates the respective entry in the central account 704 with a flag that the settlement instruction 718 has been sent. The network payment management module 708 will thus not send a duplicate settlement instruction to the server computer system bank account 700.

The server computer system bank account 700 responds to the settlement instruction 718 to transmit the settlement 720 to the credit card and issuer computer systems 282. The settlement 720 is routed to the identifier of the credit card and issuer computer systems 282 and is used as funds or money that is transferred from the server computer system bank account 700 to the credit card and issuer computer systems 282.

The network payment management module 708 transmits a credit instruction 722 directly to the credit card and issuer computer systems 282 contemporaneously with the settlement 720. The credit instruction 722 includes an instruction to credit a stored value of a respective account having the respective PAN by $2. The credit card and issuer computer systems 282 then respond to the credit instruction 722 by crediting the stored value of the account having the respective PAN by $2.

The discount of $2 has been used as an example to exemplify the overall functioning of the settlement system 702. As a practical matter, the merchant payment management module 706 may ask for a larger amount than $2 and the settlement request 714 for purposes of making a profit. The settlement request may for example include a request for a settlement of $2.50 and the settlement 716 may be for $2.50. The network payment management module 708 can then proceed to send the settlement instruction 718 of $2.00 so that a profit of $0.50 remains within the server computer system bank account 700 after the settlement 720.

### 6). Computer System

FIG. 29 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal display (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While the instructions 952 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

### 7). Mobile Device

FIG. 30 is a block diagram illustrating the mobile device 24, illustrating a touch-sensitive display 1120 or a “touch screen” for convenience. The mobile device 24 includes a memory 1020 (which may include one or more computer readable storage mediums), a memory controller 1220, one or more processing units (CPU's) 1200, a peripherals interface 1180, RF circuitry 1080, audio circuitry 1100, a speaker 1110, a microphone 1130, an input/output (I/O) subsystem 1060, other input or control devices 1160 and an external port 1240. These components communicate over one or more communication buses or signal lines 1030.

The various components shown in FIG. 30 may be implemented in hardware, software or a combination of both hardware and software, including one or more signal processing and/or application specific integrated circuits.

The memory 1020 may include high-speed random access memory and may also include non-volatile memory, such as one or more magnetic disk storage devices, flash memory devices, or other non-volatile solid-state memory devices. Access to the memory 1020 by other components of the mobile device 24, such as the CPU 1200 and the peripherals interface 1180, is controlled by the memory controller 1220.

The peripherals interface 1180 connects the input and output peripherals of the device to the CPU 1200 and memory 1020. The one or more processors 1200 run or execute various software programs and/or sets of instructions stored in the memory 1020 to perform various functions for the mobile device 24 and to process data.

The RF (radio frequency) circuitry 1080 receives and sends RF signals, also called electromagnetic signals. The RF circuitry 1080 converts electrical signals to/from electromagnetic signals and communicates with communications networks and other communications devices via the electromagnetic signals. The RF circuitry 1080 includes well-known circuitry for performing these functions, including an antenna system, an RF transceiver, one or more amplifiers, a tuner, one or more oscillators, a digital signal processor, a CODEC chipset, a subscriber identity module (SIM) card, memory, and so forth. The RF circuitry 1080 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies that are known in the art.

The audio circuitry 1100, the speaker 1110, and the microphone 1130 provide an audio interface between a user and the mobile device 24. The audio circuitry 1100 receives audio data from the peripherals interface 1180, converts the audio data to an electrical signal, and transmits the electrical signal to the speaker 1110. The speaker 1110 converts the electrical signal to human-audible sound waves. The audio circuitry 1100 also receives electrical signals converted by the microphone 1130 from sound waves. The audio circuitry 1100 converts the electrical signal to audio data and transmits the audio data to the peripherals interface 1180 for processing. The audio circuitry 1100 also includes a headset jack serving as an interface between the audio circuitry 1100 and removable audio input/output peripherals, such as output-only headphones or a headset with both output (e.g., a headphone for one or both ears) and input (e.g., a microphone).

The I/O subsystem 1060 connects input/output peripherals on the mobile device 24, such as the touch screen 1120 and other input/control devices 1160, to the peripherals interface 1180. The I/O subsystem 1060 includes a display controller 1560 and one or more input controllers 1600 for other input or control devices. The one or more input controllers 1600 receive/send electrical signals from/to other input or control devices 1160. The other input/control devices 1160 may include physical buttons (e.g., push buttons, rocker buttons, etc.), dials, slider switches, joysticks, click wheels, and so forth all serving as forming part of an interface. The input controllers 1600 may be connected to any of the following: a keyboard, infrared port, USB port, and a pointer device such as a mouse. The one or more buttons may include an up/down button for volume control of the speaker 1110 and/or the microphone 1130. The one or more buttons may include a push button. A quick press of the push button may disengage a lock of the touch screen 1120 or begin a process that uses gestures on the touch screen to unlock the device. A longer press of the push button may turn power to the mobile device 24 on or off. The touch screen 1120 is used to implement virtual or soft buttons and one or more soft keyboards.

The touch-sensitive touch screen 1120 provides an input interface and an output interface between the device and a user. The display controller 1560 receives and/or sends electrical signals from/to the touch screen 1120. The touch screen 1120 displays visual output to the user. The visual output may include graphics, text, icons, video, and any combination thereof (collectively termed “graphics”). In some embodiments, some or all of the visual output may correspond to user-interface objects, further details of which are described below.

A touch screen 1120 has a touch-sensitive surface, sensor or set of sensors that accepts input from the user based on haptic and/or tactile contact. The touch screen 1120 and the display controller 1560 (along with any associated modules and/or sets of instructions in memory 1020) detect contact (and any movement or breaking of the contact) on the touch screen 1120 and converts the detected contact into interaction with user-interface objects (e.g., one or more soft keys, icons, web pages or images) that are displayed on the touch screen. In an exemplary embodiment, a point of contact between a touch screen 1120 and the user corresponds to a finger of the user.

The touch screen 1120 may use LCD (liquid crystal display) technology, or LPD (light emitting polymer display) technology, although other display technologies may be used in other embodiments. The touch screen 1120 and the display controller 1560 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 1120.

The user may make contact with the touch screen 1120 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

The mobile device 24 also includes a power system 1620 for powering the various components. The power system 1620 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The software components stored in memory 1020 include an operating system 1260, a communication module (or set of instructions) 1280, a contact/motion module (or set of instructions) 1300, a graphics module (or set of instructions) 1320, a text input module (or set of instructions) 1340, and applications (or set of instructions) 1360.

The operating system 1260 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 1280 facilitates communication with other devices over one or more external ports 1240 and also includes various software components for handling data received by the RF circuitry 1080 and/or the external port 1240. The external port 1240 (e.g., Universal Serial Bus (USB), FIREWIRE, etc.) is adapted for coupling directly to other devices or indirectly over a network (e.g., the Internet, wireless LAN, etc.).

The contact/motion module 1300 may detect contact with the touch screen 1120 (in conjunction with the display controller 1560) and other touch sensitive devices (e.g., a touchpad or physical click wheel). The contact/motion module 1300 includes various software components for performing various operations related to detection of contact, such as determining if contact has occurred, determining if there is movement of the contact and tracking the movement across the touch screen 1120, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). The contact/motion module 1300 and the display controller 1560 also detects contact on a touchpad.

The graphics module 1320 includes various known software components for rendering and displaying graphics on the touch screen 1120, including components for changing the intensity of graphics that are displayed. As used herein, the term “graphics” includes any object that can be displayed to a user, including text, web pages, icons (such as user-interface objects including soft keys), digital images, videos, animations and the like.

The text input module 1340, which may be a component of graphics module 1320, provides soft keyboards for entering text in various applications (e.g., contacts, e-mail, IM, blogging, browser, and any other application that needs text input). The applications 1360 may include the mobile application 208.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer system for managing electronic transactions, comprising:
a server computer system including:
a processor;
a computer-readable medium connected to the processor;
a network interface device connected to the processor; and
a set of instructions on the computer-readable medium, the set of instructions being executable by the processor and including:
a plurality of merchant accounts stored in the data store, each merchant account having a merchant account identifier;
a merchant account management system receiving a voucher entry over the network interface device from a merchant computer system, the merchant offer being stored in the data store in association with the merchant account having the respective merchant account identifier;
a transaction clearing system that receives a charge advisory over the network interface device, the charge advisory including a second consumer account identifier;
a voucher redemption system matching the second merchant account identifier to one of the first merchant account identifiers to identify a selected one of the voucher entries associated with the merchant account having the first merchant account identifier; and
a settlement system having (i) at least one central account, (ii) a merchant payment management module receiving a notification from a server computer system bank account of settlement from a merchant account payment infrastructure of the discount amount, and updating the at least one central account based on the notification, and (iii) a network payment management module transmitting a settlement instruction for settlement based on the discount amount, and updating, with the processor, the at least one central account based on the settlement instruction.

2. The computer system of claim 1, wherein the merchant payment management module transmits a settlement request to a merchant account payment infrastructure for settlement based on the discount amount, the notification being in response to the settlement request.

3. The computer system of claim 2, wherein an entry of the central account includes a PAN, an amount based on the discount amount and a merchant account ID, the amount based on the discount amount and merchant account ID being transmitted to the merchant account payment infrastructure, the notification including the PAN and the amount based on the discount amount, and the settlement instruction including the discount amount and the PAN.

4. The computer system of claim 1, wherein the network payment management module transmits a credit instruction contemporaneously with the settlement instruction, the credit instruction including an account identifier to be credited by the discount amount.

5. The computer system of claim 1, wherein the charge advisory includes a second consumer account identifier, further comprising:
a plurality of consumer accounts stored in the data store, each consumer account having a first consumer account identifier;
a push module associating the voucher entry with one of the consumer accounts, identifies a selected one of the consumer accounts by associating one of the first consumer account identifiers with the second consumer account identifier;
a voucher availability module determining whether the selected consumer account is the consumer account having the voucher entry associated therewith, wherein the settlement system only transmits the settlement instruction if the selected consumer account has the voucher entry associated therewith; and
a transaction processing system that processes the charge request based on an account detail of the selected consumer account.

6. The computer system of claim 5, wherein the voucher entry in the consumer account is transmitted from over the network interface device to a mobile device based on an identifier in the consumer account having the consumer account identifier.

7. A computer-based method of managing electronic transactions, comprising:
storing, with a processor, a plurality of merchant accounts in a data store, each merchant account having a first merchant account identifier;
receiving, with the processor, a voucher entry over a network interface device from a merchant computer system;
storing, with the processor, the voucher entry having a discount amount in the data store in association with the merchant account having the respective first merchant account identifier;
receiving, with the processor, a charge advisory over the network interface device, the charge advisory including a second consumer account identifier;
matching, with the processor, the second merchant account identifier to one of the first merchant account identifiers to identify a selected one of the voucher entries associated with the merchant account having the first merchant account identifier;
receiving, with the processor, a notification from a server computer system bank account of settlement from a merchant account payment infrastructure of the discount amount;
updating, with the processor, at least one central account based on the notification;
transmitting, with the processor, a settlement instruction for settlement based on the discount amount; and
updating, with the processor, the at least one central account based on the settlement instruction.

8. The method of claim 7, further comprising:
transmitting, with the processor, a settlement request to a merchant account payment infrastructure for settlement based on the discount amount, the notification being in response to the settlement request.

9. The method of claim 8, wherein an entry of the central account includes a PAN, an amount based on the discount amount and a merchant account ID, the amount based on the discount amount and merchant account ID being transmitted to the merchant account payment infrastructure, the notification including the PAN and the amount based on the discount amount, and the settlement instruction including the discount amount and the PAN.

10. The computer system of claim 1, wherein the network payment management module transmits a credit instruction contemporaneously with the settlement instruction, the credit instruction including an account identifier to be credited by the discount amount.

11. The method of claim 7, wherein the charge advisory includes a second consumer account identifier, further comprising:
storing, with a processor, a plurality of consumer accounts in a data store, each consumer account having a first consumer account identifier;
associating, with the processor, the voucher entry with one of the consumer accounts;
identifying, with the processor, a selected one of the consumer accounts by associating one of the first consumer account identifiers with the second consumer account identifier;
determining, with the processor, whether the selected consumer account is the consumer account having the voucher entry associated therewith, wherein the processor only transmits the settlement instruction if the selected consumer account has the voucher entry associated therewith; and
processing, with the processor, the charge request based on an account detail of the selected consumer account.

12. The method of claim 11, further comprising:
transmitting the voucher entry over the network interface device to a mobile device based on an identifier in the consumer account having the consumer account identifier.

13. The method of claim 12, further comprising:
receiving, with the processor, login information from a mobile device over the network interface device, access to the merchant offer only being permitted upon successful login based on the login information.
